(19) United States
(12) Patent Application Publication
(10) Pub. No.: US 2024/0248659 A1
(43) Pub. Date: Jul. 25, 2024

(54) SERVER, PRINTING SYSTEM, INFORMATION PROCESSING METHOD, AND NON-TRANSITORY COMPUTER-READABLE STORAGE MEDIUM STORING PROGRAM

(71) Applicant: SEIKO EPSON CORPORATION, Tokyo (JP)

(72) Inventor: Yasuhiro FURUTA, SHIMOSUWA-MACHI (JP)

(21) Appl. No.: 18/418,408

(22) Filed: Jan. 22, 2024

(30) Foreign Application Priority Data
Jan. 23, 2023 (JP) 2023-007959

(51) Int. Cl. G06F 3/12

(52) U.S. Cl. CPC G06F 3/1238; G06F 3/1222; G06F 3/1288

(57) ABSTRACT

A relay server is a server connected to a first printing service system and a second printing service system, the second printing service system being connected to an image forming device. The relay server includes: an authentication controller configured to acquire authentication completion information indicating that authentication by the first printing service system for authentication information on a user that is input to a second terminal device is completed; and a printing controller configured to acquire a printing job for the user from the first printing service system using the authentication completion information and transmit a request to the second printing service system to cause the image forming device to execute printing for the printing job.

The present application is based on, and claims priority from JP Application Serial Number 2023-007959, filed Jan. 23, 2023, the disclosure of which is hereby incorporated by reference herein in its entirety.

### BACKGROUND

### 1. Technical Field

The present disclosure relates to a server, a printing system, an information processing method, and a non-transitory computer-readable storage medium storing a program.

### 2. Related Art

There has been known a technique of printing using a printer connected to a network. For example, JP-A-2016-45683 discloses one system including a printing device and a printing server. In this technique, after transmitting printing data to the printing server, a user designates a printing device to be used by reading a code image attached to the printing device with a terminal device. Accordingly, printing is performed using the designated printing device.

In a printing system using a printer connected to a network, it is necessary to introduce a technique to prevent unauthorized use of the system. In the technique disclosed in JP-A-2016-45683, the server requires input of authentication information in order to confirm whether a user has legitimate authority. In the present disclosure, printing that requires authentication in this manner is also referred to as authentication printing hereinafter. The authentication printing can prevent unauthorized use of the system. However, JP-A-2016-45683 discloses authentication printing when printing is executed using one system that provides printing service. Therefore, there is a need for a technique for implementing authentication printing when a plurality of systems that provide printing service cooperate to execute printing.

### SUMMARY

A server according to the present disclosure is a server connected to a first printing service system and a second printing service system, the second printing service system being connected to an image forming device. The server includes: an authentication control unit configured to acquire authentication completion information indicating that authentication by the first printing service system for authentication information on a user which is input to a terminal device is completed; and a printing control unit configured to acquire a printing job for the user from the first printing service system using the authentication completion information and transmit a request to the second printing service system to cause the image forming device to execute printing for the printing job.

A printing system according to the present disclosure includes: a first printing service system; an image forming device; a second printing service system connected to the image forming device; and a server connected to the first printing service system and the second printing service system. The server includes an authentication control unit configured to acquire authentication completion information indicating that authentication by the first printing service system for authentication information on a user which is input to a terminal device is completed, and a printing control unit configured to acquire a printing job for the user from the first printing service system using the authentication completion information and transmit a request to the second printing service system to cause the image forming device to execute printing for the printing job.

An information processing method according to the present disclosure causes a server connected to a first printing service system and a second printing service system, the second printing service system being connected to an image forming device, to: acquire authentication completion information indicating that authentication by the first printing service system for authentication information on a user which is input to a terminal device is completed; and acquire a printing job for the user from the first printing service system using the authentication completion information and transmit a request to the second printing service system to cause the image forming device to execute printing for the printing job.

According to a non-transitory computer-readable storage medium storing a program according to the present disclosure, the program causes a computer of a server connected to a first printing service system and a second printing service system, the second printing service system being connected to an image forming device, to execute: an authentication control step of acquiring authentication completion information indicating that authentication by the first printing service system on authentication information of a user input to a terminal device is completed; and a printing control step of acquiring a printing job for the user from the first printing service system using the authentication completion information and transmitting a request to the second printing service system to cause the image forming device to execute printing for the printing job.

### BRIEF DESCRIPTION OF THE DRAWINGS

FIG. 1 is a block diagram showing an example of a configuration of a printing system according to an embodiment.

FIG. 2 is a block diagram showing an example of a configuration of a first printing service system according to the embodiment.

FIG. 3 is a block diagram showing an example of a configuration of a second printing service system according to the embodiment.

FIG. 4 is a block diagram showing an example of a configuration of a relay server according to the embodiment.

FIG. 5 is a block diagram showing an example of a configuration of a first terminal device according to the embodiment.

FIG. 6 is a block diagram showing an example of a configuration of a second terminal device according to the embodiment.

FIG. 7 is a block diagram showing an example of a configuration of an image forming device according to the embodiment.

FIG. 8A is a sequence chart showing an example of a flow of a code virtual printer registration process.

FIG. 8B is a sequence chart showing the example of the flow of the code virtual printer registration process.

FIG. 8C is a sequence chart showing the example of the flow of the code virtual printer registration process.

FIG. 9 is a sequence chart showing an example of a flow of a setting process of a rule related to use of the image forming device.

FIG. 10 is a sequence chart showing an example of a flow of a process in which the printing system receives printing data.

FIG. 11A is a sequence chart showing an example of a flow of a printing process.

FIG. 11B is a sequence chart showing the example of the flow of the printing process.

FIG. 11C is a sequence chart showing the example of the flow of the printing process.

FIG. 11D is a sequence chart showing the example of the flow of the printing process.

FIG. 11E is a sequence chart showing the example of the flow of the printing process.

FIG. 11F is a sequence chart showing the example of the flow of the printing process.

FIG. 11G is a sequence chart showing the example of the flow of the printing process.

FIG. 11H is a sequence chart showing the example of the flow of the printing process.

### DESCRIPTION OF EMBODIMENTS

Hereinafter, an embodiment will be described with reference to the drawings. To clarify the description, the following description and drawings are omitted and simplified as appropriate. In the drawings, the same elements are denoted by the same reference numerals, and a redundant description thereof is omitted as necessary.

As described above, it is preferable that even when different systems that provide printing service cooperate with each other, authentication printing can be implemented in order to prevent unauthorized use of the system to execute printing. Therefore, in the embodiment, a technique for implementing authentication printing in a printing system in which different systems that provide printing service cooperate with each other will be described. In the present disclosure, in addition to such a technique, the following technique can be implemented. That is, the present disclosure further implements a technique in which a user designates an image forming device to be used for printing using a code image attached to the image forming device in the printing system in which different systems that provide printing service cooperate with each other.

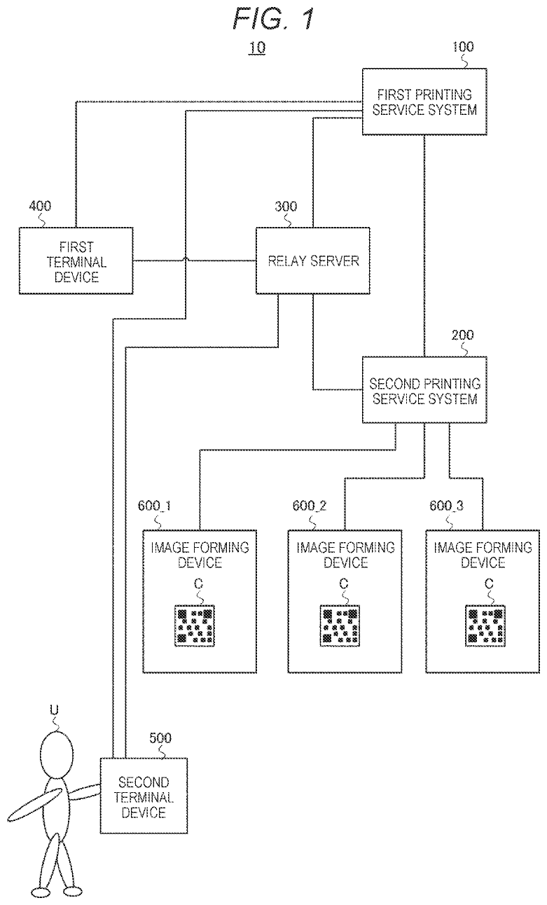

FIG. 1 is a block diagram showing an example of a configuration of a printing system 10 according to an embodiment. The printing system 10 includes a first printing service system 100, a second printing service system 200, and a relay server 300. FIG. 1 also shows a first terminal device 400, a second terminal device 500, and image forming devices 600_1, 600_2, and 600_3 that are communicably connected to the printing system 10. In the following description, the image forming devices 600_1, 600_2, and 600_3 are referred to as image forming devices 600 when they are not particularly distinguished. FIG. 1 also shows a user U who carries the second terminal device 500 and moves to the front of the image forming device 600 that the user U desires to use.

A system including the first terminal device 400 may be referred to as the printing system 10. Similarly, a system including the second terminal device 500 may be referred to as the printing system 10, and a system including the image forming device 600 may be referred to as the printing system 10.

The first printing service system 100 and the second printing service system 200 are systems that provide printing service on the cloud. Here, the first printing service system 100 is a system for service provided by a first vendor, and the second printing service system 200 is a system for service provided by a second vendor different from the first vendor. For example, the second vendor is a vendor that manufactures the image forming device 600.

The image forming device 600 is a device having a function of performing a printing process. In the embodiment, specifically, the image forming device 600 is a printer. In the embodiment, the image forming device 600 is registered in the second printing service system 200 in advance as a device capable of executing a printing process for a printing job managed by the second printing service system 200.

The first terminal device 400 and the second terminal device 500 are client terminals such as a personal computer (PC), a smartphone, and a tablet terminal. Particularly, the second terminal device 500 is preferably a mobile terminal that can be easily carried by the user U. The first terminal device 400 and the second terminal device 500 may be the same terminal device.

The relay server 300 is a server that acts as a bridge between the first printing service system 100 and the second printing service system 200, and relays a process in the printing system 10.

A code image C is attached to the image forming device 600. The code image C includes at least identification information for uniquely identifying the image forming device 600. In the embodiment, the code image C further includes information indicating a predetermined access destination. Specifically, the information indicating a predetermined access destination is, for example, a uniform resource locator (URL) for accessing the relay server 300. The code image C may be an image encoded with the information described above, and may be a barcode or a two-dimensional code such as a QR code (registered trademark). The code image C attached to the image forming device 600 that the user U desires to use is read by the second terminal device 500 through an operation of the user U.

In the embodiment, the image forming device 600 may be a device managed by a specific organization. That is, the image forming device 600 may be a device belonging to a specific organization. Each image forming device 600 may be managed by a separate organization. For example, the image forming devices 600_1 and 600_2 may be managed by a first organization, and the image forming device 600_3 may be managed by a second organization.

As shown in FIG. 1, the first printing service system 100 and the second printing service system 200 are communicably connected. The relay server 300 is communicably connected to the first printing service system 100 and the second printing service system 200, separately. The image forming device 600 is communicably connected to the second printing service system 200. The first terminal device 400 and the second terminal device 500 are communicably connected to at least the first printing service system 100 and the relay server 300. In addition to the connection relationship described above, a further connection relationship may exist between the components. For example, the first terminal device 400 and the second terminal device 500 may be communicably connected to the second printing service system 200.

Although three image forming devices 600 are shown as an example in FIG. 1, the number of image forming devices 600 that use the printing system 10 is any. Similarly, although one first terminal device 400 and one second terminal device 500 are shown as an example, the number of the first terminal devices 400 and the second terminal devices 500 that use the printing system 10 are any.

As described above, the first printing service system 100 and the second printing service system 200 are both systems that provide printing service on the cloud. Therefore, when a printer is registered in a printing service system, printing by the printer via the printing service system is possible. However, when the printer is not compatible with a protocol used by the printing service system, the printer cannot be directly registered in the printing service system. In the embodiment, the image forming device 600 is compatible with a protocol used by the second printing service system 200, and can be directly registered in the second printing service system 200. However, the image forming device 600 is not necessarily compatible with a protocol used by the first printing service system 100.

Therefore, in the embodiment, printing is performed by the image forming device 600 via the first printing service system 100 by associating a printer registered as a virtual printer (a virtual device) in the first printing service system 100 with the image forming device 600 registered in the second printing service system 200. This association is performed by the relay server 300. Although the image forming device 600 is not compatible with the protocol of the first printing service system 100, there is a case where the user desires to print by the image forming device 600 using printing service provided by the first printing service system 100. Examples of such a case include a case where installation of a printer driver for the image forming device 600, which is required in the second printing service system 200, is not necessary in the first printing service system 100. Of course, the user may desire to print by the image forming device 600 using the first printing service system 100 for any other reason. In such a case, the relay server 300 needs to associate the image forming device 600 registered in the second printing service system 200 with the virtual printer registered in the first printing service system 100. The first printing service system 100 provides printing service using, for example, the Internet printing protocol shared infrastructure extensions (IPP-Infra) as the protocol described above, whereas the second printing service system 200 provides printing service without using the protocol.

In the embodiment, the user U moves to the front of the image forming device 600 and reads the code image C attached to the image forming device 600 with the second terminal device 500, thereby designating the image forming device 600 that the user U is to use for printing. That is, in the embodiment, an output destination of a printed matter is designated by reading the code image C. Therefore, in the embodiment, as described later, the relay server 300 registers a dedicated virtual printer for a printing job in which an output destination is designated by reading the code image C in the first printing service system 100 in advance, and when the code image C is read, the dedicated virtual printer is associated with the image forming device 600 specified from the read code image C.

In the embodiment, as described later, the relay server 300 requires authentication completion information indicating that authentication of the user U by the first printing service system 100 is completed as a condition for processing a printing request from the user U. Accordingly, the authentication printing can be implemented in the printing system 10 in which different systems that provide printing service cooperate with each other.

Hereinafter, a specific configuration and process of the printing system 10 will be described. Configurations of the first printing service system 100, the second printing service system 200, the relay server 300, the first terminal device 400, the second terminal device 500, and the image forming device 600 will be described with reference to the drawings.

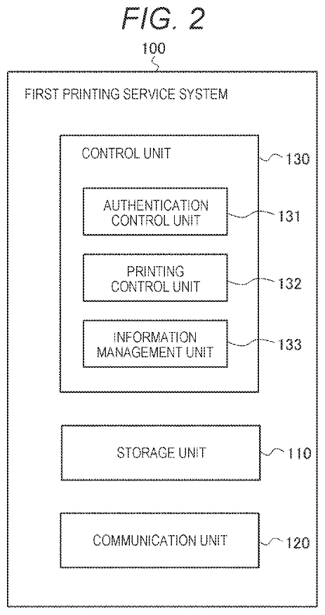

FIG. 2 is a block diagram showing an example of the configuration of the first printing service system 100. In the example shown in FIG. 2, although the first printing service system 100 includes one server, the first printing service system 100 may include a plurality of servers.

As shown in FIG. 2, the first printing service system 100 includes a storage unit 110, a communication unit 120, and a control unit 130.

The storage unit 110 is a storage device that stores a program for implementing a process of the control unit 130 and data used for a process of the first printing service system 100. The storage device may be a nonvolatile storage device such as a hard disk or a flash memory, or may include a memory such as a random access memory (RAM). The storage unit 110 may also include a database. The communication unit 120 is a communication interface for communicating with other devices such as the second printing service system 200, the relay server 300, the first terminal device 400, and the second terminal device 500 via a wireless network or a wired network. The control unit 130 is a processor, such as a central processing unit (CPU), that controls components of the first printing service system 100. The control unit 130 may include a plurality of processors. The control unit 130 reads a program into the memory and executes the program. Accordingly, the control unit 130 implements functions of an authentication control unit 131, a printing control unit 132, and an information management unit 133.

The authentication control unit 131 performs various processes related to authentication of a user who uses the first printing service system 100. The user of the first printing service system 100 includes a user who is an administrator and a user who is a general user other than the administrator. The user who is an administrator can also be referred to as a user who has administrator authority. The user who is a general user may be referred to as a user who has user authority, which is authority more limited than administrator authority. In the embodiment, it is assumed that these users are registered in the first printing service system 100 in advance. The authentication control unit 131 provides a page for authentication to the first terminal device 400 or the second terminal device 500, authenticates an administrator or a general user, and issues a token necessary for accessing the first printing service system 100. A specific process of the authentication control unit 131 in the embodiment will be described using a sequence chart to be described later.

The printing control unit 132 performs a control process for executing printing by a printer registered in the first printing service system 100. In the embodiment, the printing control unit 132 performs the control process when printing by the image forming device 600 via a virtual printer registered in the first printing service system 100. However, the printing control unit 132 may also perform a control process when printing by a physical printer registered directly, not as a virtual printer, in the first printing service system 100. Specifically, in the embodiment, the printing control unit 132 performs a process of receiving a printing request from the first terminal device 400, a process of transmitting information necessary for printing according to the printing request to the relay server 300, a process of notifying the first terminal device 400 or the second terminal device 500 of a job state, and the like. A specific process of the printing control unit 132 in the embodiment will be described using a sequence chart to be described later.

The information management unit 133 performs a process of registering a printer in the first printing service system 100. The information management unit 133 manages information on a user registered in the first printing service system 100. The information on the user includes, for example, authentication information on the user and identification information on a user organization which is an organization to which the user belongs (an organization ID). The authentication information on the user includes identification information on the user (a user ID) and verification information such as a password or a personal identification number. The information management unit 133 may manage information on a printer registered in the first printing service system 100. For example, the information management unit 133 may manage a printer name, a printer ID, capability information, and share information, of the registered printer. The information management unit 133 may further perform a process of registering a user in the first printing service system 100. A specific process of the information management unit 133 in the embodiment will be described using a sequence chart to be described later.

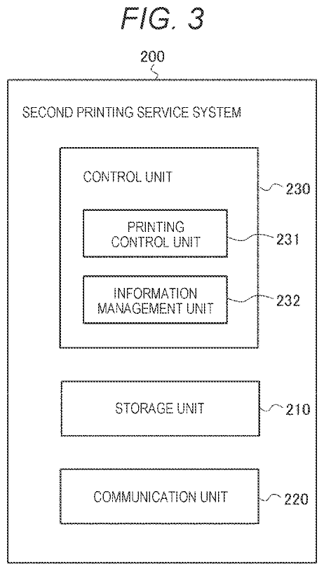

FIG. 3 is a block diagram showing an example of the configuration of the second printing service system 200. In the example shown in FIG. 3, although the second printing service system 200 includes one server, the second printing service system 200 may include a plurality of servers.

As shown in FIG. 3, the second printing service system 200 includes a storage unit 210, a communication unit 220, and a control unit 230.

The storage unit 210 is a storage device that stores a program for implementing a process of the control unit 230 and data used for a process of the second printing service system 200. The storage device may be a nonvolatile storage device such as a hard disk or a flash memory, and may include a memory such as a RAM. The storage unit 210 may also include a database. The communication unit 220 is a communication interface for communicating with other devices such as the first printing service system 100, the relay server 300, and the image forming device 600 via a wireless network or a wired network. The control unit 230 is a processor, such as a CPU, that controls components of the second printing service system 200. The control unit 230 may include a plurality of processors. The control unit 230 reads a program into the memory and executes the program. Accordingly, the control unit 230 implements functions of a printing control unit 231 and an information management unit 232.

The printing control unit 231 performs a control process for executing printing by the image forming device 600 which is a printer registered in the second printing service system 200. Specifically, in the embodiment, the printing control unit 231 performs a process of receiving a printing request from the relay server 300, a process of transmitting information necessary for printing according to the printing request to the image forming device 600, a process of notifying the relay server 300 of a job state, and the like. A specific process of the printing control unit 231 in the embodiment will be described using a sequence chart to be described later.

The information management unit 232 manages information registered in the second printing service system 200. For example, the information management unit 232 manages information on the image forming device 600 which is a printer registered in the second printing service system 200. The information management unit 232 may manage attribute information on the registered image forming device 600, such as a printer name and capability information, as information on the image forming device 600, that is, information on the printer. The information management unit 232 may perform a process of registering the image forming device 600 in the second printing service system 200.

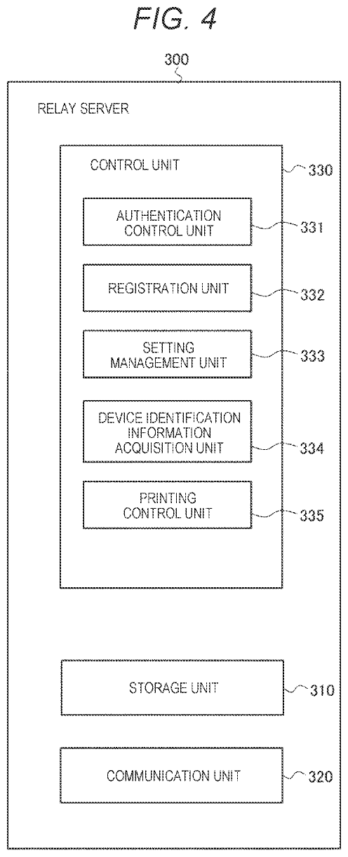

FIG. 4 is a block diagram showing an example of the configuration of the relay server 300. In the example shown in FIG. 4, although the relay server 300 includes one server, the relay server 300 may include a plurality of servers. The relay server 300 may be referred to as a server.

As shown in FIG. 4, the relay server 300 includes a storage unit 310, a communication unit 320, and a control unit 330.

The storage unit 310 is a storage device that stores a program for implementing a process of the control unit 330 and data used for a process of the relay server 300. The storage device may be a nonvolatile storage device such as a hard disk or a flash memory, and may include a memory such as a RAM. The storage unit 310 may also include a database. The storage unit 310 stores, for example, a correspondence relationship between a virtual printer and the image forming device 600, setting information on use of the image forming device 600, and a correspondence relationship between a printing job of the first printing service system 100 and a printing job of the second printing service system 200. The setting information on the use of the image forming device 600 includes a rule related to the use of the image forming device 600 that is predetermined by an administrator or the like. The setting information on the use of the image forming device 600 may include a user instruction related to application of the rule described above. The storage unit 310 may store a different rule for each user organization. The storage unit 310 may store a different instruction for each user. The communication unit 320 is a communication interface for communicating with other devices such as the first printing service system 100, the second printing service system 200, the first terminal device 400, and the second terminal device 500 via a wireless network or a wired network. The control unit 330 is a processor, such as a CPU, that controls components of the relay server 300. The control unit 330 may include a plurality of processors. The control unit 330 reads a program into the memory and executes the program. Accordingly, the control unit 330 implements functions of an authentication control unit 331, a registration unit 332, a setting management unit 333, a device identification information acquisition unit 334, and a printing control unit 335.

The authentication control unit 331 performs various processes for receiving authentication by the first printing service system 100. Particularly, the authentication control unit 331 performs a process of acquiring authentication completion information. Here, the authentication completion information is information indicating that authentication by the first printing service system 100 for the authentication information on the user that is input to the first terminal device 400 or the second terminal device 500 is completed. In the embodiment, the authentication completion information is, specifically, a token (hereinafter, referred to as an access token) necessary for accessing the first printing service system 100. A specific process of the authentication control unit 331 in the embodiment will be described using a sequence chart to be described later.

The registration unit 332 performs a process of registering a virtual printer (a virtual device) in the first printing service system 100. Particularly, the registration unit 332 registers a dedicated virtual printer for a printing job in which an output destination is designated by reading the code image C in order to enable designation of the output destination by reading the code image C in the printing system 10 in which different systems that provide printing service cooperate with each other. Hereinafter, such a virtual printer is referred to as a code virtual printer.

The image forming device 600 associated with the code virtual printer changes depending on the code image C of which image forming device 600 the user reads with the second terminal device 500. The association of the image forming device 600 with the code virtual printer is temporary, and a new association is set every time a printing operation is performed, that is, every time the output destination is designated using the code image C. Therefore, the code virtual printer can also be referred to as a virtual printer that can be associated with any image forming device 600. The association between the code virtual printer and the image forming device 600 is performed by the printing control unit 335, as described later. Instead of designating the image forming device 600 as the output destination using the code image C, a virtual printer registered in the first printing service system 100 may be fixedly associated with any image forming devices 600 such that an output by the specific image forming device 600 can be designated when making a printing request to the first printing service system 100.

In the embodiment, the first printing service system 100 performs a virtual printer registration process only in response to a registration request with administrator authority, and does not approve registration in response to a registration request without administrator authority. Therefore, the registration unit 332 performs a process of registering a virtual printer in the first printing service system 100 using qualification information corresponding to the administrator authority. As described above, in the embodiment, the administrator authority is required to execute the registration process, but the administrator authority is not necessarily required. A specific process of the registration unit 332 in the embodiment will be described using a sequence chart to be described later.

The setting management unit 333 performs a process of managing a setting related to the use of the image forming device 600. The setting management unit 333 generates a rule related to the use of the image forming device 600 based on an instruction from the user who is an administrator. The rule is generated for each user organization based on an instruction from an administrator of the organization. Therefore, the setting management unit 333 generates a different rule for each user organization. The rule is generated for each image forming device 600 for each user organization. That is, the rule related to the use is set for each user organization and for each image forming device 600. The administrator may instruct that a common rule is generated for all image forming devices 600 managed by the same organization. That is, the rule related to the use may be set for each organization that manages the image forming device 600. In the embodiment, the rule is applied when any user who belongs to the user organization to which the administrator who instructs to generate the rule belongs uses the image forming device 600. In the embodiment, the rule is generated based on an instruction from an administrator of a user organization to which a user to whom the rule applies belongs, but the rule is not necessarily generated based on the instruction from such an administrator. The setting management unit 333 stores the generated rule in the storage unit 310 as setting information on the use of the image forming device 600.

Hereinafter, examples of the rule to be generated are shown. The rule to be generated is not limited to the following examples.
<Rule 1>: Use of the image forming device 600 as a rule target is prohibited.

In the case of the rule 1, the user who performs the printing operation cannot use the image forming device 600 to which the rule is applied.
<Rule 2>: A notification is always made to warn of the use of the image forming device 600 as a rule target. The user who performs the printing operation selects whether to use the image forming device 600.

In the case of the rule 2, after confirming the warning every time, the user who performs the printing operation determines whether to use the image forming device 600 to which the rule is applied.
<Rule 3>: A notification is basically made to warn of the use of the image forming device 600 as a rule target. The warning for the image forming device 600 may be omitted based on an instruction from the user. The user who performs the printing operation selects whether to use the image forming device 600.

In the case of the rule 3, after confirming the warning once, the user who performs the printing operation determines whether to use the image forming device 600 to which the rule is applied. When determining that the image forming device 600 may be used, the user can also instruct the relay server 300 not to give a notification of the warning for next and subsequent use of the image forming device 600. The user may not give such an instruction.
<Rule 4>: A notification is basically made to warn of the use of the image forming device 600 as a rule target. Based on an instruction from the user, a warning for the image forming device 600 or a warning for all the image forming devices 600 managed in the same organization as the image forming device 600 can be omitted. The user who performs the printing operation selects whether to use the image forming device 600.

In the case of the rule 4, after confirming the warning once, the user who performs the printing operation determines whether to use the image forming device 600 to which the rule is applied. When determining that the image forming device 600 may be used, the user can instruct the relay server 300 not to give a notification of the warning for next and subsequent use of the image forming device 600, or can instruct the relay server 300 not to give a notification of the warning for next and subsequent use of all the image forming devices 600 managed in the same organization as the image forming device 600. The user may not give such an instruction.
<Rule 5>: Use of the image forming device 600 as a rule target is permitted.

In the case of the rule 5, the user who performs the printing operation can freely use the image forming device 600 to which the rule is applied without being notified of a warning for use.

For example, an administrator of a certain user organization gives an instruction to generate the rule 5 for the image forming device 600 managed by this user organization since it is considered that the image forming device 600 managed by the own organization is a safe output destination. On the other hand, the administrator considers that the image forming devices 600 not managed by the own organization are not necessarily safe output destinations, and gives an instruction to generate any one of the rules 1 to 4 for the image forming devices 600. In this case, the administrator determines which of the rules 1 to 4 is to be generated in consideration of a safety degree of each image forming device 600.

The setting management unit 333 manages the instruction related to application of the rule from the user who performs the printing operation in association with identification information on the user and identification information on the target image forming device 600. For example, the setting management unit 333 manages the instruction related to the warning notification together with the identification information on the user and the identification information on the image forming device 600. When the user who receives the warning gives an instruction to set such that the use is always prohibited, the setting management unit 333 may manage the instruction in association with the identification information on the user and the identification information on the image forming device 600. The setting management unit 333 stores the received instruction as setting information on the use of the image forming device 600 in the storage unit 310 in association with the identification information on the user and the identification information on the image forming device 600. When an instruction target is all the image forming devices 600 belonging to a specific user organization, the setting management unit 333 may store the instruction in the storage unit 310 in association with the identification information on the organization.

The device identification information acquisition unit 334 acquires the identification information on the image forming device 600 that is included in the code image C attached to the image forming device 600. More specifically, the device identification information acquisition unit 334 acquires, from the second terminal device 500, the identification information on the image forming device 600 which is included in the code image C read by the second terminal device 500.

The printing control unit 335 performs a control process for executing printing by the image forming device 600 which is a printer registered in the second printing service system 200. In other words, the printing control unit 335 performs a control process for executing printing by the image forming device 600 associated with the virtual printer registered in the first printing service system 100. At this time, the printing control unit 335 associates the code virtual printer with the image forming device 600 based on the identification information on the image forming device 600 that is included in the code image C. The printing control unit 335 performs a process of acquiring information required for printing from the first printing service system 100, a process of transmitting a printing request to the second printing service system 200 based on the information, a process of notifying the first printing service system 100 of a job state, and the like.

Particularly, in the embodiment, the printing control unit 335 performs the following processes. The printing control unit 335 acquires a printing job for the user from the first printing service system 100 using the authentication completion information acquired by the authentication control unit 331, and transmits a request to the second printing service system 200 to cause the image forming device 600 to execute printing for the printing job. Therefore, when the authentication completion information cannot be acquired, the printing control unit 335 does not acquire the printing job for the user from the first printing service system 100. Therefore, in such a case, printing is not executed. As described above, in the embodiment, authentication printing using authentication by the first printing service system 100 can be implemented in printing by the image forming device 600 connected to the second printing service system 200. Therefore, unauthorized use of the system can be prevented.

Particularly, when the device identification information acquisition unit 334 acquires the identification information on the image forming device 600 that is included in the code image C, the printing control unit 335 acquires, from the first printing service system 100, a printing job in which use of the code virtual printer registered in the first printing service system 100 is designated. More specifically, the printing control unit 335 acquires a printing job corresponding to the user who performs the printing operation among such printing jobs. The printing control unit 335 transmits a request to the second printing service system 200 to cause the image forming device 600 identified by the identification information acquired by the device identification information acquisition unit 334 to execute printing for the printing job. Therefore, in the embodiment, even in the printing system in which different systems that provide printing service cooperate with each other, the user can designate the image forming device 600 to be used for printing by using the code image C attached to the image forming device 600.

The printing control unit 335 refers to the rule related to the use of the image forming device 600 identified by the identification information acquired by the device identification information acquisition unit 334, which is applied to the user who performs the printing operation (a user corresponding to the printing job to be processed). Specifically, the printing control unit 335 refers to the setting information stored in the storage unit 310. The printing control unit 335 executes a process of controlling the use of the image forming device 600 identified by the identification information by the user according to the referred rule. Accordingly, even when various users use the printing system 10, the use of the image forming device 600 can be controlled according to the rule corresponding to each user.

The process of controlling the use by the user includes a process of prohibiting the use of the image forming device 600 identified by the identification information acquired by the device identification information acquisition unit 334. In this case, the printing control unit 335 may transmit to the second terminal device 500 a notification indicating that the use of the image forming device 600 is prohibited. The process of controlling the use by the user includes a process of transmitting to the second terminal device 500 a notification warning of the use of the image forming device 600 identified by the identification information acquired by the device identification information acquisition unit 334. The printing control unit 335 executes the processes according to the setting information stored in the storage unit 310, that is, the rule generated by the setting management unit 333.

For example, the following processes are performed based on the rules 1 to 5 described above. For example, when the device identification information acquisition unit 334 acquires the identification information on the image forming device 600 for which the rule 1 is set, the printing control unit 335 transmits to the second terminal device 500 a notification indicating that the use of the image forming device 600 is prohibited.

For example, when the device identification information acquisition unit 334 acquires the identification information on the image forming device 600 for which any one of the rules 2 to 4 is set, the printing control unit 335 transmits to the second terminal device 500 a notification warning of the use of the image forming device 600. On the other hand, the user transmits an instruction to the relay server 300 to select whether to use the image forming device 600 via the second terminal device 500. The user who receives the warning for the image forming device 600 to which the rule 3 is applied can also give an instruction to omit next and subsequent warnings for the image forming device 600. Similarly, the user who receives the warning for the image forming device 600 to which the rule 4 is applied can give an instruction to omit next and subsequent warnings for all the image forming devices 600 of the same organization as the image forming device 600.

The user who receives the warning for the image forming device 600 to which any one of the rules 2 to 4 is applied can select, as an instruction to refuse the use of the image forming device 600 as a warning target, either an instruction to continuously refuse the use or an instruction to temporarily refuse the use. The instruction to temporarily refuse the use is an instruction not to use only this time. The instruction to continuously refuse the use is an instruction not to use not only this time but also next and subsequent times. The instruction to continuously refuse the use may be an instruction to continuously refuse the use of the image forming device 600 as the warning target, or an instruction to continuously refuse the use of all the image forming devices 600 managed by the same organization as the image forming device 600 as the warning target.

For example, when the device identification information acquisition unit 334 acquires the identification information on the image forming device 600 for which the rule 5 is set, the printing control unit 335 permits the use of the image forming device 600 without warning.

As described above, in the embodiment, the printing control unit 335 restricts the use of the image forming device 600 according to the predetermined rule. Therefore, the image forming device 600, whose safety is not sufficiently confirmed, can be prevented from being used without any attention being paid by the user.

For example, in the printing system in which an output destination can be designated using the code image C, when a malicious person or the like newly attaches, to the image forming device 600_1, the code image C attached to the image forming device 600_2, a printed matter may be stolen. The user who reads the code image C of the image forming device 600_1 with the second terminal device 500 waits for the printed matter to be output from the image forming device 600_1 in front of the user. However, in reality, the code image C including the identification information on the image forming device 600_2 is read, and thus the printed matter is output from the image forming device 600_2. In this case, the malicious person can get the printed matter output from the image forming device 600_2. However, in the embodiment, as described above, such a risk can be reduced by setting, for example, any one of the rules 1 to 4 for the image forming device 600 whose safety is not sufficiently confirmed. This is because, when the device identification information acquisition unit 334 acquires the identification information on the image forming device 600, the printing control unit 335 can warn of or prohibit the use of the image forming device 600. Thus, according to the embodiment, the user can more safely designate the image forming device 600 to be used for printing by using the code image C attached to the image forming device 600.

The notified warning preferably includes information indicating an organization that manages the image forming device 600 as a warning target. Hereinafter, the organization that manages the image forming device 600 is referred to as a device organization. Accordingly, the user can determine whether to use the image forming device 600 after determining whether the image forming device 600 is a device managed by a reliable organization. That is, the user can determine the safety of the image forming device 600 based on the organization that manages the image forming device 600. In the warning, it is preferable that the information indicating the device organization include information such as a domain name of the device organization, which can confirm that the existence of the organization is recognized by a public institution. The notified warning may include information indicating a legitimate installation location of the image forming device 600. Not limited to such information, the printing control unit 335 can include any information in the notified warning. For example, the notified warning may include information indicating whether the image forming device 600 is used for the first time by the user.

When acquiring a printing stop instruction from the second terminal device 500, the printing control unit 335 transmits a printing stop request to the second printing service system 200. Then, the printing control unit 335 acquires, from the second printing service system 200, information on whether printing is successfully stopped, and notifies the second terminal device 500 of the information. Accordingly, the user can confirm whether the printing is successfully stopped. This brings about the following advantages in terms of security. There are two possible cases as to why the printed matter is not immediately output from the image forming device 600 that the user assumes as the output destination. The first case is a case where it takes time to execute the printing process, and the second case is a case where the printed matter is already output from another image forming device 600. In the second case, the user may be unaware that the printed matter is already output from the image forming device 600 different from the image forming device 600 in front of the user, and the printed matter may be stolen. In the embodiment, when the user instructs to stop printing in a case where the printed matter is not output from the image forming device 600 in front of the user, the second terminal device 500 is notified of whether the printing is successfully stopped. When the second case described above occurs, the printed matter is already output, and therefore it is notified that the printing failed to be stopped. Therefore, the user can grasp that the second case occurs. Therefore, an advantage in terms of security is obtained by the process described above. The printing control unit 335 may give a notification of the number of printing jobs for which the printing is successfully stopped or failed to be stopped.

As described above, when the user instruction related to application of the rule is present, the printing control unit 335 executes a process of controlling the use of the image forming device 600 by the user according to the rule and the instruction. For example, the printing control unit 335 acquires, from the second terminal device 500, an instruction as to whether to output the warning for the image forming device 600 as the warning target next time. The acquired instruction is managed by the setting management unit 333 as the setting information. In response to the instruction, the printing control unit 335 determines whether to output the warning the next time the user uses the image forming device 600. Specifically, when the identification information on the image forming device 600 is acquired during the process of the printing job corresponding to the user, the printing control unit 335 determines whether to give the warning in accordance with the instruction from the user. For example, when an instruction to omit the notification of the warning for the image forming device 600 for which the rule 3 or 4 is set is present, the printing control unit 335 permits the use of the image forming device 600 without giving a notification of the warning. According to such a configuration, the user can be prevented from receiving a warning every time, and thus user convenience is improved.

For example, the printing control unit 335 acquires, as an instruction to refuse the use of the image forming device 600 as the warning target, an instruction to continuously refuse the use or an instruction to temporarily refuse the use from the second terminal device 500. Among them, the instruction to continuously refuse the use, that is, an instruction to set the use to be always prohibited is managed by the setting management unit 333 as the setting information. When the instruction to continuously refuse the use is acquired, that is, when such an instruction is managed as the setting information, the printing control unit 335 also prohibits the next and subsequent use of the image forming device 600 by the user. According to such a configuration, the image forming device 600 that the user does not desire to use can be reliably prevented from being used in the future, and thus the user convenience is improved.

As described above, the instruction to omit the warning may be an instruction to prevent the warning from being notified in the future for all the image forming devices 600 managed by the same organization as the image forming device 600 as the warning target. In this case, when the device identification information acquisition unit 334 acquires the identification information on any image forming device 600, the printing control unit 335 omits the warning for the image forming device 600 and permits the use regardless of the set rule. As described above, the instruction to continuously refuse the use may be an instruction to continuously refuse the use of all the image forming devices 600 managed by the same organization as the image forming device 600 as the warning target. In this case, when the device identification information acquisition unit 334 acquires the identification information on any image forming device 600, the printing control unit 335 prohibits the next and subsequent use of the image forming device 600. As described above, the printing control unit 335 may acquire the instruction to refuse the use of all the image forming devices 600 belonging to a specific device organization or the instruction to output the warning for all the image forming devices 600 belonging to a specific device organization, and apply the instruction to all the image forming devices 600 belonging to the device organization when processing a printing job corresponding to the user who gives the instruction. Accordingly, the user can collectively set the image forming devices 600 managed by the specific organization, and thus the user convenience is improved.

Although the process of the printing control unit 335 has been described, a specific process of the printing control unit 335 in the embodiment will be described using a sequence chart to be described later. Next, the configuration of the first terminal device 400 will be described.

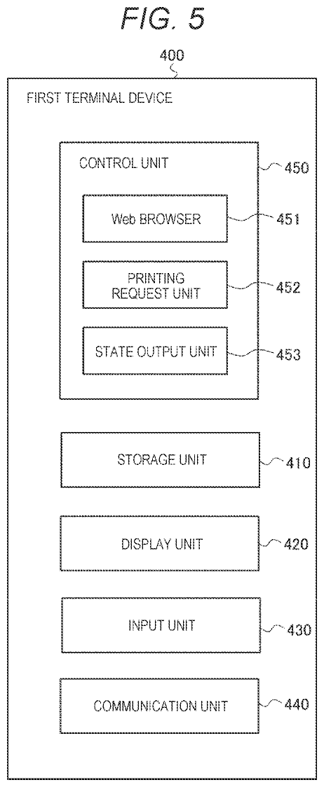

FIG. 5 is a block diagram showing an example of the configuration of the first terminal device 400. As shown in FIG. 5, the first terminal device 400 includes a storage unit 410, a display unit 420, an input unit 430, a communication unit 440, and a control unit 450.

The storage unit 410 is a storage device that stores a program for implementing a process of the control unit 450 and data used for a process of the first terminal device 400. The storage device may be a nonvolatile storage device such as a hard disk or a flash memory, and may include a memory such as a RAM. The display unit 420 is a device for displaying information, and is a display such as a flat panel display. The input unit 430 is a device that receives an input operation from a user, and is, for example, a keyboard or a mouse. The display unit 420 and the input unit 430 may be integrally provided by a touch panel or the like. The communication unit 440 is a communication interface for communicating with other devices such as the first printing service system 100 and the relay server 300 via a wireless network or a wired network. The control unit 450 is a processor, such as a CPU, that controls components of the first terminal device 400. The control unit 450 may include a plurality of processors. The control unit 450 reads a program into the memory and executes the program. Accordingly, the control unit 450 implements functions of a web browser 451, a printing request unit 452, and a state output unit 453.

The web browser 451 is a known web browser. In the embodiment, the web browser 451 performs a process of displaying a web page provided from the first printing service system 100 or the relay server 300 on the display unit 420, a process of transmitting input information for the web page, and the like. A specific process of the web browser 451 according to the embodiment will be described using a sequence chart to be described later.

The printing request unit 452 performs a process of requesting printing in response to an operation from the user. In the embodiment, particularly, the printing request unit 452 requests the first printing service system 100 to perform printing. A specific process of the printing request unit 452 in the embodiment will be described using a sequence chart to be described later.

The state output unit 453 acquires a job state to be described later via the first printing service system 100 and outputs the job state. In the embodiment, the state output unit 453 outputs the job state to the display unit 420, but the output does not necessarily have to be displayed. For example, the state output unit 453 may output the job state by voice or the like. The state output unit 453 may be provided in the first terminal device 400 as a function of the web browser 451. A specific process of the state output unit 453 in the embodiment will be described using a sequence chart to be described later.

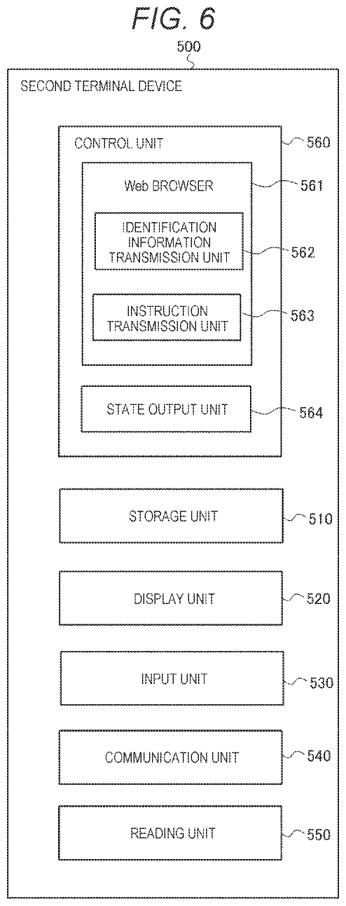

FIG. 6 is a block diagram showing an example of the configuration of the second terminal device 500. As shown in FIG. 5, the second terminal device 500 includes a storage unit 510, a display unit 520, an input unit 530, a communication unit 540, a reading unit 550, and a control unit 560.

The storage unit 510 is a storage device that stores a program for implementing a process of the control unit 560 and data used for a process of the second terminal device 500. The storage device may be a nonvolatile storage device such as a hard disk or a flash memory, and may include a memory such as a RAM. The display unit 520 is a device for displaying information, and is a display such as a flat panel display. The input unit 530 is a device that receives an input operation from a user, and is, for example, a keyboard or a mouse. As described above, since the second terminal device 500 is preferably a mobile terminal, the display unit 520 and the input unit 530 are preferably integrally provided by a touch panel or the like. The communication unit 540 is a communication interface for communicating with other devices such as the first printing service system 100 and the relay server 300 via a wireless network or a wired network. The reading unit 550 is a device that reads the code image C attached to the image forming device 600. Specifically, the reading unit 550 is a camera, for example. The control unit 560 is a processor, such as a CPU, that controls components of the second terminal device 500. The control unit 560 may include a plurality of processors. The control unit 560 reads a program into the memory and executes the program. Accordingly, the control unit 560 implements functions of a web browser 561, an identification information transmission unit 562, an instruction transmission unit 563, and a state output unit 564.

The web browser 561 is a known web browser. In the embodiment, the web browser 561 performs a process of displaying a web page provided from the first printing service system 100 or the relay server 300 on the display unit 520, a process of transmitting input information for the web page, and the like. Particularly, in the embodiment, the web browser 561 functions as the identification information transmission unit 562. The identification information transmission unit 562 transmits, to the relay server 300, the identification information on the image forming device 600 which is included in the code image C read by the reading unit 550. In the embodiment, the web browser 561 functions as the instruction transmission unit 563. The instruction transmission unit 563 transmits, to the relay server 300, an instruction from the user input via the input unit 530. Particularly, the instruction transmission unit 563 transmits an instruction to select whether to use the image forming device 600 warned by the relay server 300, an instruction related to application of the rule described above, an instruction to execute printing, an instruction to stop printing, and the like. A specific process of the web browser 561 according to the embodiment will be described using a sequence chart to be described later.

The state output unit 564 acquires a job state to be described later via the first printing service system 100 and outputs the job state. In the embodiment, the state output unit 564 outputs the job state to the display unit 520, but the output does not necessarily have to be displayed. For example, the state output unit 564 may output the job state by voice or the like. A specific process of the state output unit 564 in the embodiment will be described using a sequence chart to be described later.

In the configuration shown in FIG. 6, although the identification information transmission unit 562 and the instruction transmission unit 563 have been described as the function of the web browser 561, the identification information transmission unit 562 and the instruction transmission unit 563 are not necessarily provided as the function of the web browser 561. That is, the identification information transmission unit 562 and the instruction transmission unit 563 may exist in the second terminal device 500 as a function independent of the web browser 561. The state output unit 564 may be provided in the second terminal device 500 as a function of the web browser 561. The control unit 560 of the second terminal device 500 may have the same function as the printing request unit 452 of the first terminal device 400.

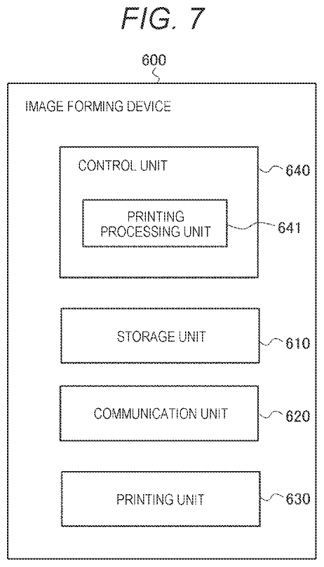

FIG. 7 is a block diagram showing an example of the configuration of the image forming device 600. As shown in FIG. 7, the image forming device 600 includes a storage unit 610, a communication unit 620, a printing unit 630, and a control unit 640.

The storage unit 610 is a storage device that stores a program for implementing a process of the control unit 640 and data used for a process of the image forming device 600. The storage device may be a nonvolatile storage device such as a hard disk or a flash memory, and may include a memory such as a RAM. The communication unit 620 is a communication interface for communicating with other devices such as the second printing service system 200 via a wireless network or a wired network. The control unit 640 is a processor, such as a CPU, that controls components of the image forming device 600. The control unit 640 may include a plurality of processors. The control unit 640 reads a program into the memory and executes the program. Accordingly, the control unit 640 implements a function of a printing processing unit 641.

The printing processing unit 641 performs a process for executing printing by the printing unit 630. The printing processing unit 641 notifies the second printing service system 200 of a job state of a printing job. A specific process of the printing processing unit 641 in the embodiment will be described using a sequence chart to be described later.

The printing unit 630 has a printing function for forming an image on a printing medium such as paper. The printing unit 630 includes a printing engine. The printing engine is a mechanical configuration that prints an image on a printing medium using a color material. The printing engine may include a mechanism for printing using ink by, for example, an inkjet method. Alternatively, the printing engine may include a mechanism for printing using toner by, for example, electrophotography. The printing engine may include a transport mechanism for transporting the printing medium.

The image forming device 600 may further include a user interface such as a touch panel display. In the embodiment, as described above, the image forming device 600 includes the printing unit 630 and has a function of a printer. Therefore, the image forming device 600 is also referred to as a printer.

Next, a flow of a process of the printing system 10 will be described using a sequence chart.

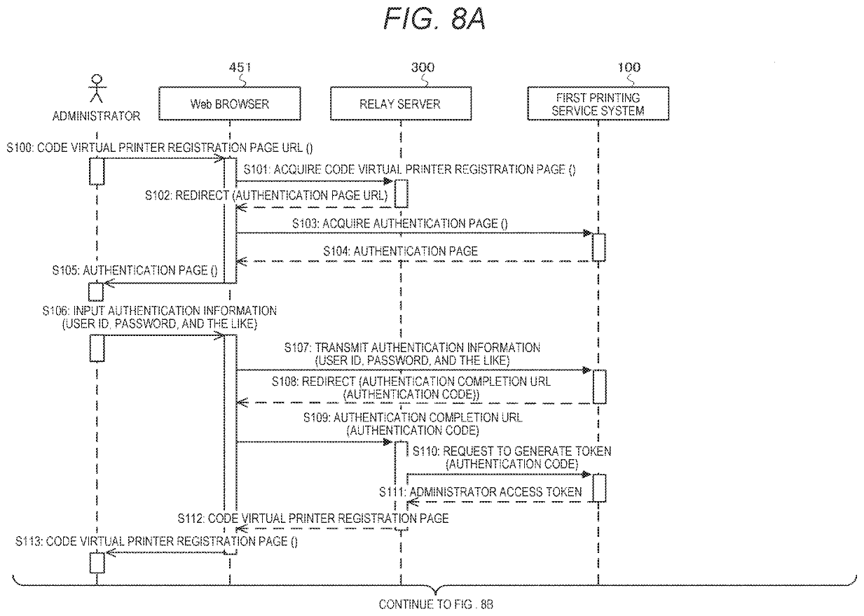

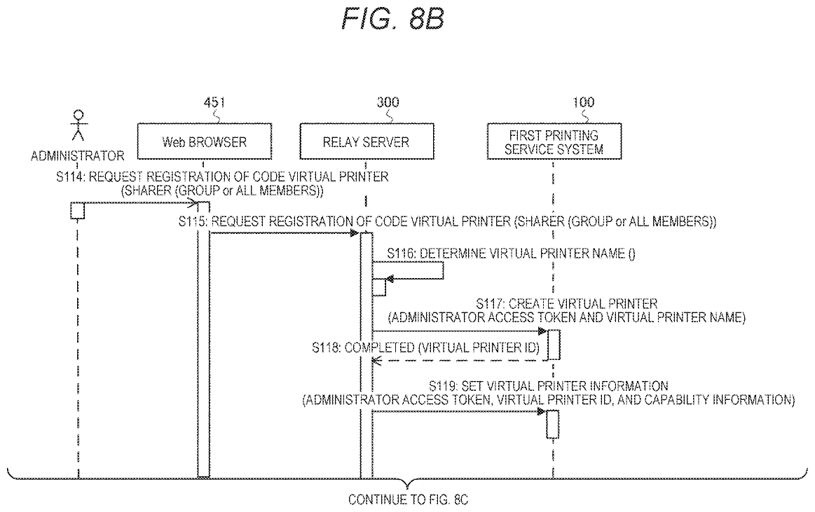

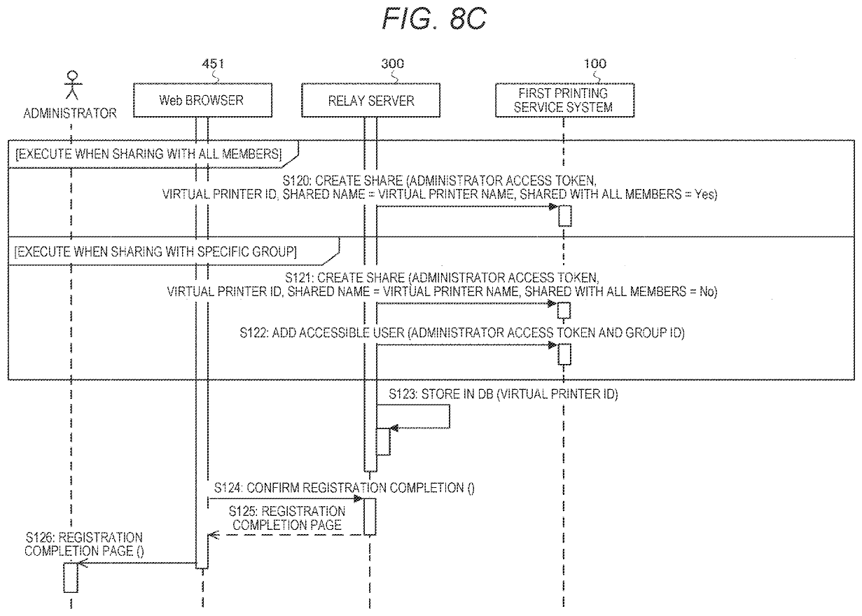

First, a flow of a process for registering a code virtual printer in the first printing service system 100 in order to enable designation of an output destination by reading the code image C will be described. That is, a flow of a process for registering, in the first printing service system 100, a dedicated virtual printer for a printing job in which an output destination is designated by reading the code image C will be described. FIGS. 8A to 8C are sequence charts showing an example of a flow of a code virtual printer registration process executed in the printing system 10. A process order of steps in the sequence chart is merely an example, and can be changed as appropriate unless technically inconsistent. The flow of the code virtual printer registration process will be described below with reference to FIGS. 8A to 8C.

In step S100, the administrator performs a predetermined operation for starting the code virtual printer registration process via the input unit 430 of the first terminal device 400. Accordingly, for example, a URL of a code virtual printer registration page is input to the web browser 451 of the first terminal device 400. Here, the code virtual printer registration page is a page prepared for registering the code virtual printer in the first printing service system 100. After step S100, in step S101, the web browser 451 transmits a request to the relay server 300 to acquire the code virtual printer registration page according to the input URL. On the other hand, in step S102, the authentication control unit 331 of the relay server 300 instructs the web browser 451 to access a predetermined redirect page. In the present step, the predetermined redirect page is an authentication page. Therefore, the authentication control unit 331 of the relay server 300 transmits a URL of the authentication page to the web browser 451. The authentication page is a page for requesting the user to input authentication information.

In step S103, the web browser 451 transmits a request to the first printing service system 100 to acquire the authentication page according to the received URL. On the other hand, in step S104, the authentication control unit 131 of the first printing service system 100 transmits the authentication page to the web browser 451. Accordingly, in step S105, the web browser 451 displays the authentication page on the display unit 420 of the first terminal device 400.

In step S106, the administrator inputs the authentication information to the authentication page via the input unit 430. Specifically, for example, the administrator inputs a user ID of the administrator and a password. Here, the required authentication information is authentication information used in the first printing service system 100. Specifically, the required authentication information is a user ID and a password that are registered in advance. In step S107, the web browser 451 transmits the input authentication information to the first printing service system 100. The authentication control unit 131 of the first printing service system 100 performs an authentication process based on the authentication information received from the web browser 451. That is, the authentication control unit 131 determines whether the received authentication information matches the authentication information on the administrator that is registered in advance.

When the authentication is successful in the authentication process, that is, when the received authentication information matches the authentication information on the administrator that is registered in advance, in step S108, the authentication control unit 131 of the first printing service system 100 issues an authentication code and further instructs the web browser 451 to access a predetermined redirect destination. The predetermined redirect destination is the relay server 300. By this redirect, the authentication code is passed to the relay server 300. Therefore, the authentication control unit 131 of the first printing service system 100 transmits a URL indicating the predetermined redirect destination to the web browser 451 together with the authentication code.

In step S109, the web browser 451 accesses the predetermined redirect destination with the authentication code. Accordingly, the relay server 300 acquires the authentication code. In step S110, the authentication control unit 331 of the relay server 300 transmits a request to the first printing service system 100 to generate an administrator access token, together with the received authentication code. The administrator access token is information certifying that the access is a legitimate access of the administrator, that is, an access with legitimate authority of the administrator. In step S111, after confirming that the authentication code received in step S110 matches the authentication code transmitted in step S108, the authentication control unit 131 of the first printing service system 100 issues the administrator access token and transmits the administrator access token to the relay server 300. Thereafter, in step S112, the registration unit 332 transmits the code virtual printer registration page to the web browser 451. Accordingly, in step S113, the web browser 451 displays the code virtual printer registration page on the display unit 420 of the first terminal device 400.

In step S114, the administrator performs a predetermined operation of requesting registration of the code virtual printer via the input unit 430 of the first terminal device 400. In step S114, more specifically, the administrator inputs information designating a sharer to the code virtual printer registration page displayed in step S113. The sharer is a user who can use the code virtual printer. The information designating a sharer may be information designating a user belonging to a specific group as the sharer. In this case, the information designating a sharer may be identification information specifying a group, such as a group ID. Instead of the identification information specifying a group, a user ID of each of a plurality of users designated as the sharer may be input. The information designating a sharer may be information designating any user, that is, all users, as the sharer.

Next, in step S115, the web browser 451 transmits a request to the relay server 300 to register a code virtual printer in the first printing service system 100, together with the information designating a sharer. Accordingly, the registration unit 332 of the relay server 300 acquires a code virtual printer registration instruction from the administrator.

Next, in step S116, the registration unit 332 of the relay server 300 determines a printer name of the code virtual printer to be registered in the first printing service system 100. The registration unit 332 determines, for example, a predetermined printer name with which the user can identify the code virtual printer as the printer name of the code virtual printer to be registered in the first printing service system 100.

Next, in step S117, the registration unit 332 of the relay server 300 requests the first printing service system 100 to register the code virtual printer using the administrator access token acquired in step S111. Specifically, in step S117, the registration unit 332 transmits a request to the first printing service system 100 to create and register the code virtual printer, together with the administrator access token. At this time, the registration unit 332 transmits the virtual printer name determined in step S116 together with the request. That is, the registration unit 332 requests the registration of the virtual printer and the setting of the virtual printer name.

On the other hand, in step S118, when the authentication control unit 131 confirms that the administrator access token received in step S117 is legitimate, the information management unit 133 of the first printing service system 100 registers a new virtual printer in the first printing service system 100. At this time, the information management unit 133 sets the virtual printer name received in step S117 as the printer name of the virtual printer to be newly registered. The information management unit 133 determines a virtual printer ID for the new virtual printer as the identification information thereof, and notifies the relay server 300 of completion of the registration of the virtual printer together with the virtual printer ID.

Thereafter, in step S119 to step S122, a setting process for the newly registered virtual printer is performed. Specifically, in step S119, the registration unit 332 of the relay server 300 transmits a request to the first printing service system 100 to set capability information on the newly registered virtual printer, together with the administrator access token. At this time, the registration unit 332 also transmits the virtual printer ID notified in step S118 and capability information together with the request. The capability information is information indicating capability of the image forming device 600 associated with the code virtual printer as a printer, and can also be said to be information specifying a function of the image forming device 600 as a printer. The capability information may be, for example, information indicating whether double-sided printing is possible or information indicating whether color printing is possible. As described above, any image forming device 600 may be associated with the code virtual printer. Therefore, the registration unit 332 may transmit, as the capability information, only a function common to all the image forming devices 600 that may be associated with the code virtual printer, or may transmit, as the capability information, information indicating that the capability is unknown. On the other hand, when the authentication control unit 131 confirms that the administrator access token received in step S119 is legitimate, the information management unit 133 of the first printing service system 100 sets the virtual printer specified by the received virtual printer ID. More specifically, the information management unit 133 uses the received capability information as the capability information on the code virtual printer specified by the received virtual printer ID. Accordingly, the capability information on the created code virtual printer is set.

In step S120, step S121, and step S122, the registration unit 332 of the relay server 300 performs a setting related to shared use of the newly registered virtual printer. That is, in step S120, step S121, and step S122, an access right for the code virtual printer is set. Here, the following specific processes are performed in order to set the code virtual printer to be used as a shared printer. The shared printer is a printer that is assumed to be used by a plurality of users. That is, the shared printer is a printer shared by a plurality of users. When the shared printer, which is the code virtual printer, is shared by any user, that is, when the relay server 300 receives information designating any user as a sharer in step S115, the registration unit 332 executes a process in step S120 described below. When the shared printer, which is the code virtual printer, is to be shared by users belonging to a specific group, that is, when the relay server 300 receives information designating users belonging to a specific group as a sharer in step S115, the registration unit 332 executes processes in step S121 and step S122 described below.

When the relay server 300 receives the information designating any user as a sharer, in step S120, the registration unit 332 performs a process for generating share information. As described above, in this case, since it is necessary to allow any user to use the code virtual printer, share information permitting sharing to any user is created. More specifically, in step S120, the registration unit 332 transmits a request to the first printing service system 100 to set share information on a newly registered code virtual printer, together with the administrator access token. At this time, the registration unit 332 also transmits the virtual printer ID notified in step S118 and an instruction to designate that sharing to any user is permitted together with the request. In the description in step S120 of the sequence chart, a description in which “Yes” is set to a value of a flag indicating sharing with all members (“sharing with all members=Yes”) represents the instruction to designate that sharing to any user is permitted. At this time, the registration unit 332 may also transmit a shared name for identifying newly created share information to the first printing service system 100. For example, the virtual printer name determined in step S116 may be used as such a shared name. The transmission of the shared name may be omitted. On the other hand, when the authentication control unit 131 confirms that the administrator access token received in step S120 is legitimate, the information management unit 133 of the first printing service system 100 creates, based on the received information, share information on the virtual printer specified by the virtual printer ID. Specifically, the information management unit 133 creates share information indicating that sharing to any user is permitted.

When the relay server 300 receives the information designating a user belonging to a specific group as a sharer, in step S121, the registration unit 332 first performs a process for generating share information. Since it is necessary to prevent a user other than the user belonging to the specific group from using the code virtual printer, share information not permitting sharing to any user is created. More specifically, in step S121, the registration unit 332 transmits a request to the first printing service system 100 to set share information on the newly registered virtual printer, together with the administrator access token. At this time, the registration unit 332 also transmits the virtual printer ID notified in step S118 and an instruction to designate that sharing to any user is not permitted together with the request. In the description in step S121 of the sequence chart, a description in which “No” is set to a value of a flag indicating sharing with all members (“sharing with all members=No”) represents the instruction to designate that sharing to any user is not permitted. At this time, the registration unit 332 may also transmit a shared name for identifying newly created share information to the first printing service system 100. For example, the virtual printer name determined in step S116 may be used as such a shared name. The transmission of the shared name may be omitted. On the other hand, when the authentication control unit 131 confirms that the administrator access token received in step S121 is legitimate, the information management unit 133 of the first printing service system 100 creates, based on the received information, share information on the virtual printer specified by the virtual printer ID. Specifically, the information management unit 133 creates share information indicating that sharing to any user is not permitted.

In step S122, the registration unit 332 performs a process of correcting the share information such that only users belonging to the specific group can use the printer to be registered. Specifically, in step S122, the registration unit 332 transmits a request to the first printing service system 100 to correct the share information so as to permit the user belonging to the specific group to use the virtual printer, together with the administrator access token. At this time, the registration unit 332 transmits, for example, the group ID acquired in step S115 as information for specifying the user who is permitted to share. On the other hand, when the authentication control unit 131 confirms that the administrator access token received in step S122 is legitimate, the information management unit 133 of the first printing service system 100 updates the share information based on received information. Specifically, the information management unit 133 updates the share information so as to permit the use of the user specified by the received group ID. In the sequence chart shown in FIG. 8C, the share information setting is performed over two steps, i.e., step S121 and step S122, but the process may be performed in one step.

After step S120 or step S122, in step S123, the registration unit 332 of the relay server 300 stores the virtual printer ID of the virtual printer registered as the code virtual printer in the database of the storage unit 310 or the like.

In step S124, the web browser 451 inquires the relay server 300 of whether the code virtual printer registration process is completed. On the other hand, in step S125, the registration unit 332 of the relay server 300 transmits a registration completion page, which is a page indicating that the registration is completed, to the web browser 451. Accordingly, in step S126, the web browser 451 displays the registration completion page on the display unit 420 of the first terminal device 400. In the sequence chart shown here, a step of inquiring whether the code virtual printer registration process is completed is performed after step S123, and may be performed periodically before step S123. In this case, the registration unit 332 may transmit a page indicating that the registration is not completed to the web browser 451.

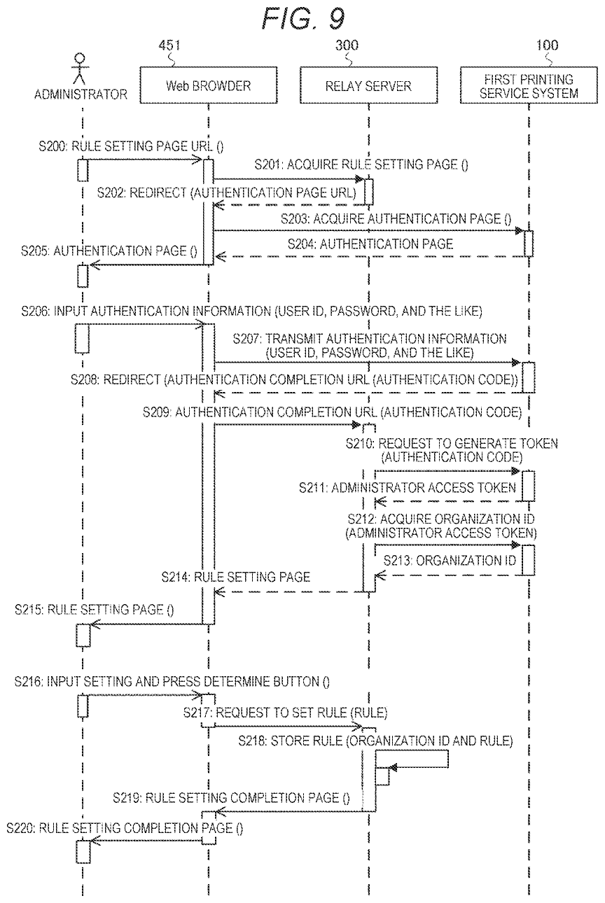

Next, a flow of a setting process of the above-described rule related to the use of the image forming device 600 will be described. FIG. 9 is a sequence chart showing an example of the flow of the setting process of the rule related to the use of the image forming device 600. A process order of steps in the sequence chart is merely an example, and can be changed as appropriate unless technically inconsistent. The flow of the setting process of the rule will be described below with reference to FIG. 9.

In step S200, the administrator performs a predetermined operation for starting the setting process of the rule via the input unit 430 of the first terminal device 400. Accordingly, for example, a URL of a rule setting page is input to the web browser 451 of the first terminal device 400. Here, the rule setting page is a page prepared for setting the rule related to the use of the image forming device 600. After step S200, in step S201, the web browser 451 transmits a request to the relay server 300 to acquire the rule setting page according to the input URL. On the other hand, in step S202, the authentication control unit 331 of the relay server 300 instructs the web browser 451 to access a predetermined redirect page. In the present step, the predetermined redirect page is an authentication page. Therefore, the authentication control unit 331 of the relay server 300 transmits a URL of the authentication page to the web browser 451.

In step S203, the web browser 451 transmits a request to the first printing service system 100 to acquire the authentication page according to the received URL. On the other hand, in step S204, the authentication control unit 131 of the first printing service system 100 transmits the authentication page to the web browser 451. Accordingly, in step S205, the web browser 451 displays the authentication page on the display unit 420 of the first terminal device 400.

In step S206, the administrator inputs authentication information to the authentication page via the input unit 430. Specifically, for example, the administrator inputs a user ID of the administrator and a password. Here, the required authentication information is authentication information used in the first printing service system 100. Specifically, the required authentication information is a user ID and a password that are registered in advance. In step S207, the web browser 451 transmits the input authentication information to the first printing service system 100. The authentication control unit 131 of the first printing service system 100 performs an authentication process based on the authentication information received from the web browser 451. That is, the authentication control unit 131 determines whether the received authentication information matches the authentication information on the administrator that is registered in advance.

When the authentication is successful in the authentication process, that is, when the received authentication information matches the authentication information on the administrator that is registered in advance, in step S208, the authentication control unit 131 of the first printing service system 100 issues an authentication code and instructs the web browser 451 to access a predetermined redirect destination. The predetermined redirect destination is the relay server 300. By this redirect, the authentication code is passed to the relay server 300. Therefore, the authentication control unit 131 of the first printing service system 100 transmits a URL indicating the predetermined redirect destination to the web browser 451 together with the authentication code.

In step S209, the web browser 451 accesses the predetermined redirect destination with the authentication code. Accordingly, the relay server 300 acquires the authentication code. In step S210, the authentication control unit 331 of the relay server 300 transmits a request to the first printing service system 100 to generate an administrator access token, together with the received authentication code. In step S211, after confirming that the authentication code received in step S210 matches the authentication code transmitted in step S208, the authentication control unit 131 of the first printing service system 100 issues an administrator access token and transmits the administrator access token to the relay server 300.

Next, in step S212, the setting management unit 333 of the relay server 300 transmits a request to the first printing service system 100 to acquire an organization ID of the administrator, together with the administrator access token acquired in step S211. The organization ID of the administrator is identification information on a user organization to which the administrator belongs, in other words, identification information on a user organization managed by the administrator. As described above, in the embodiment, a rule applied when any user belonging to the user organization to which the administrator who instructs to generate the rule belongs uses the image forming device 600 is generated. Therefore, it is necessary to associate the generated rule with the organization ID. Therefore, in the present step, the setting management unit 333 transmits a request to acquire the organization ID.

On the other hand, in step S213, when the authentication control unit 131 confirms that the administrator access token received in step S212 is legitimate, the information management unit 133 of the first printing service system 100 transmits the organization ID of the administrator to the relay server 300. Specifically, the information management unit 133 transmits the organization ID to the relay server 300. Accordingly, the setting management unit 333 of the relay server 300 acquires the organization ID of the administrator. Thereafter, in step S214, the setting management unit 333 transmits a rule setting page to the web browser 451. Accordingly, in step S215, the web browser 451 displays the rule setting page on the display unit 420 of the first terminal device 400.

The rule setting page is, for example, a page for providing a user interface for setting the rule related to the use of the image forming device 600, and the administrator can set a desired rule for each image forming device 600. As described above, the administrator may set the rule for using the image forming device 600 for each device organization using the rule setting page. The set rule may be a rule regarding whether to permit the use of the image forming device 600, or may be a rule regarding whether to give a notification of a warning when the image forming device 600 is used. Specifically, for example, the administrator sets any one of the rules 1 to 5 described above for each image forming device 600. In step S216, the administrator performs an input for setting the rule on the rule setting page via the input unit 430, and presses a determination button displayed on the rule setting page. In step S217, the web browser 451 transmits the setting information on the input rule to the first printing service system 100, and requests the relay server 300 to set the rule. On the other hand, in step S218, the setting management unit 333 of the relay server 300 generates a rule according to the setting information and stores the rule in the storage unit 310 in association with the organization ID acquired in step S213.

Thereafter, in step S219, the setting management unit 333 transmits a rule setting completion page to the web browser 451. The rule setting completion page is a page for notifying that the rule is stored as appropriate in the relay server 300. Accordingly, in step S220, the web browser 451 displays the rule setting completion page on the display unit 420 of the first terminal device 400.

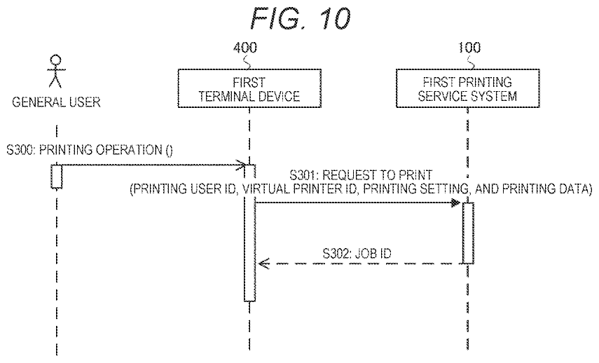

Next, a flow of a process in which the printing system 10 receives data to be printed will be described. Hereinafter, the data to be printed is referred to as printing data. FIG. 10 is a sequence chart showing an example of the flow of the process in which the printing system 10 receives the printing data. Hereinafter, the flow of the process will be described with reference to FIG. 10.

In step S300, a general user belonging to the user organization performs a predetermined operation for printing the printing data via the input unit 430 of the first terminal device 400. Specifically, for example, the general user performs an operation of designating a virtual printer to be used for printing, printing data, and a printing setting. In the embodiment, the user designates the image forming device 600 to be used for printing by using the code image C attached to the image forming device 600. Therefore, in the present step, the user designates the code virtual printer as the virtual printer to be used for printing. The printing setting designated in step S300 is a setting value set in the printer for printing. Examples of the printing setting include, but are not limited to, a setting value for designating a size of paper to be used, a setting value for designating whether to perform color printing, and a setting value for designating whether to perform duplex printing.

When the operation in step S300 is performed, in step S301, the printing request unit 452 of the first terminal device 400 requests the first printing service system 100 to execute printing. At this time, the printing request unit 452 transmits, to the first printing service system 100, the user ID of the user who instructs printing in step S300, the virtual printer ID of the code virtual printer, the designated printing setting, and the designated printing data. Then, the first printing service system 100 acquires the user ID, the virtual printer ID, the designated printing setting, and the designated printing data. The printing control unit 132 of the first printing service system 100 receives only a request to perform printing using the code virtual printer from a user, who is a sharer of the code virtual printer, and does not receive the request from other users.

Next, in step S302, the printing control unit 132 of the first printing service system 100 generates a printing job based on the information received in step S301, and notifies the first terminal device 400 of a job ID, which is identification information on the printing job. The generated printing job remains stored in the first printing service system 100 until the user instructs printing after determining the image forming device 600 as an output destination using the code image C. At this time, the printing job is stored in the first printing service system 100 in association with the virtual printer ID of the code virtual printer and the user ID.

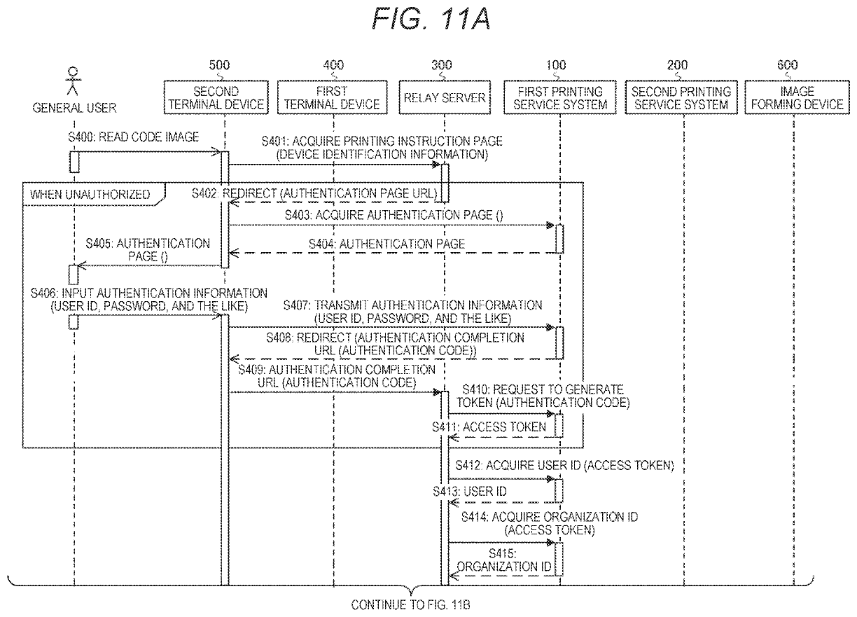

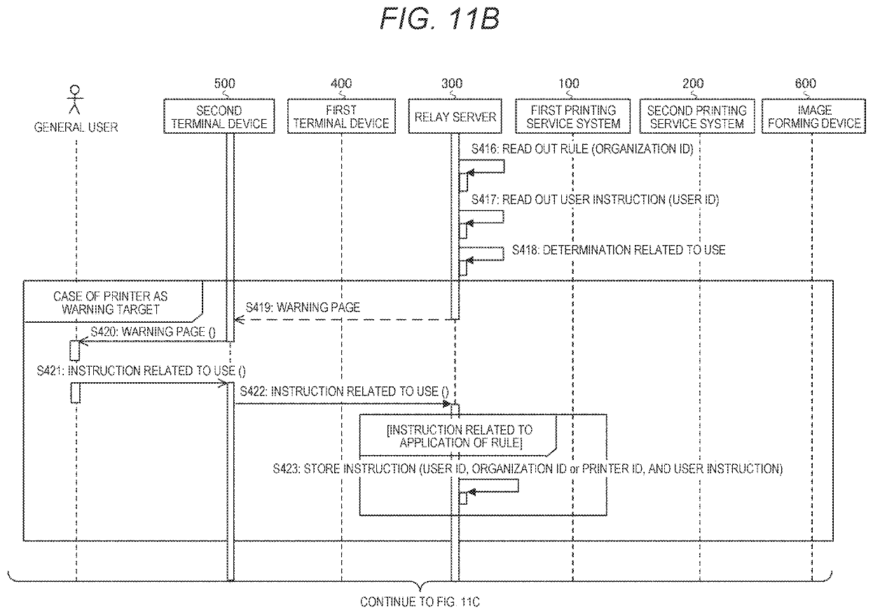

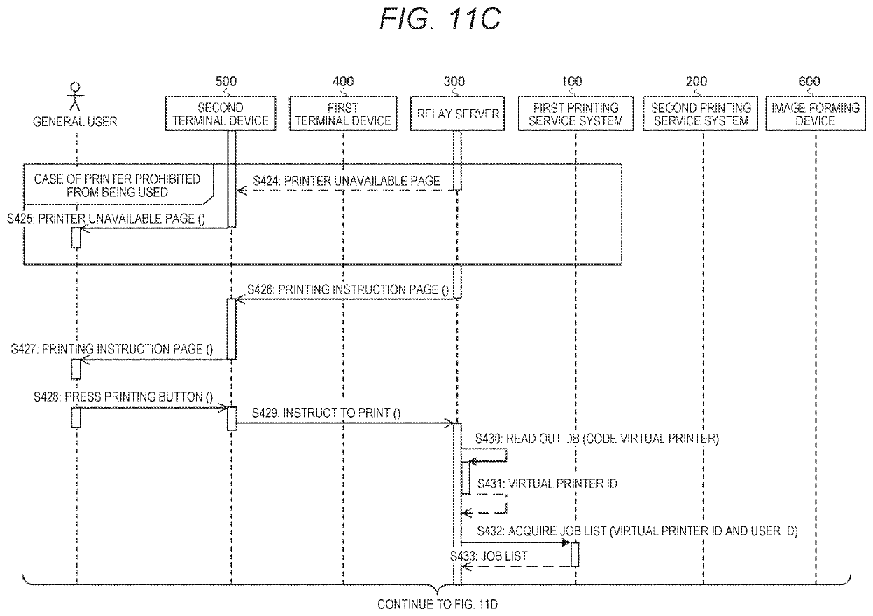

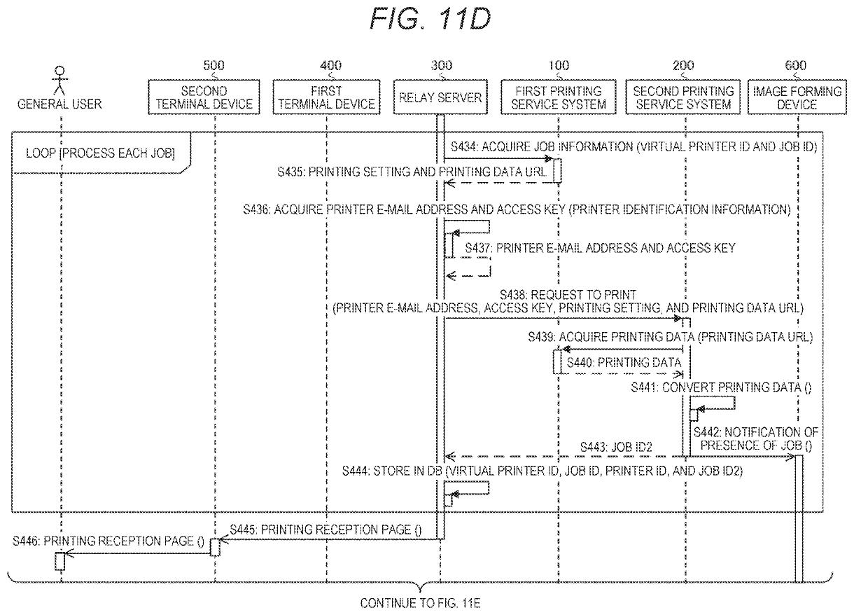

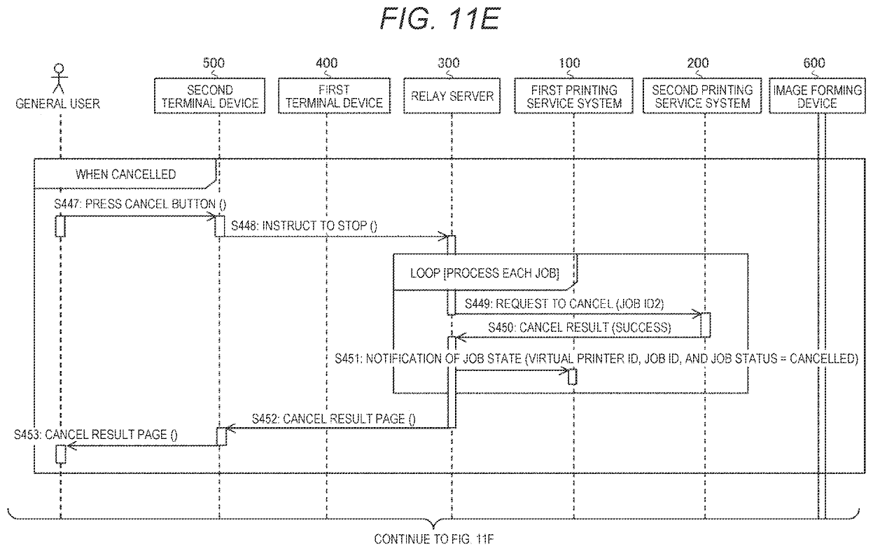

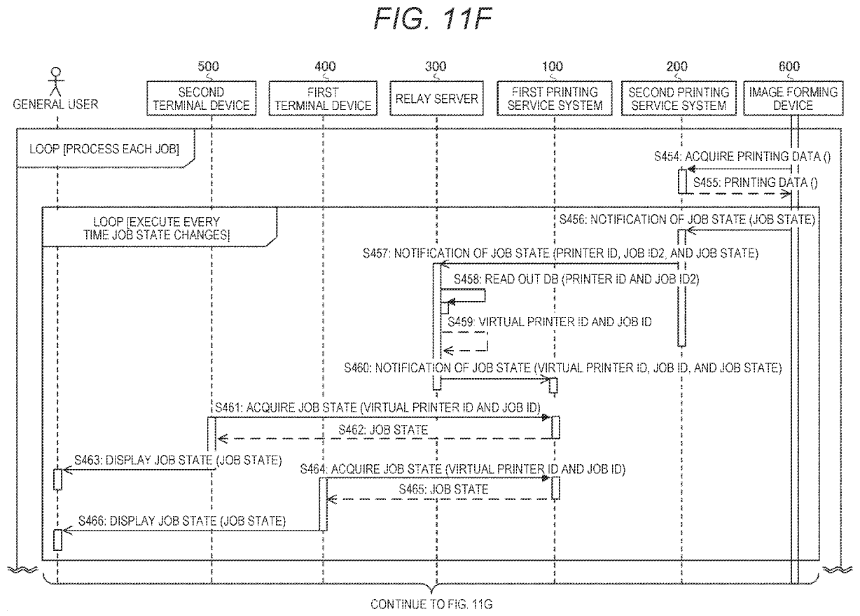

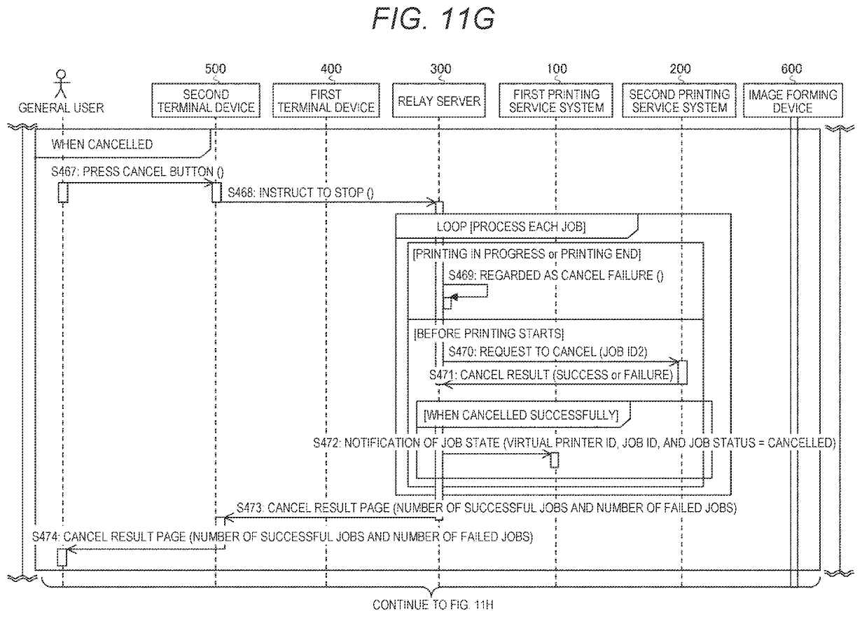

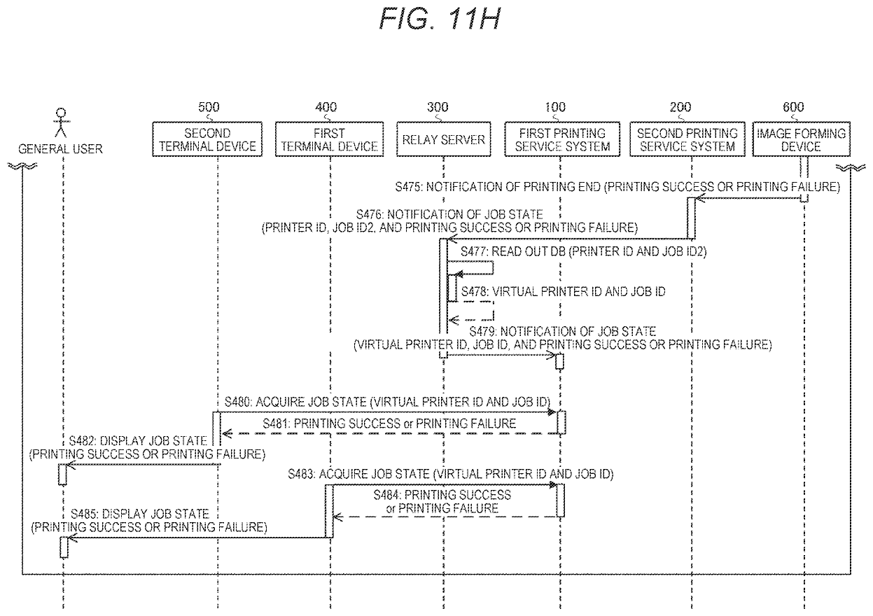

Next, a flow of a printing process when printing is performed by the user with the image forming device 600 specified by the code image C read by the second terminal device 500 will be described. FIGS. 11A to 11H are sequence charts showing an example of the flow of the printing process executed in the printing system 10. A process order of steps in the sequence chart is merely an example, and can be changed as appropriate unless technically inconsistent. Hereinafter, the flow of the printing process will be described with reference to FIGS. 11A to 11H.

After performing the operation in step S300 in FIG. 10, the general user moves to the image forming device 600 from which the printed matter is desired to be acquired. In step S400, the general user uses the reading unit 550 of the second terminal device 500 to read the code image C attached to the image forming device 600 from which the printed matter is desired to be acquired. The code image C includes device identification information, which is identification information on the image forming device 600, and a URL for accessing the relay server 300.

After step S400, in step S401, the web browser 561 transmits a request to the relay server 300 to acquire a printing instruction page according to the URL obtained from the code image C. Here, the printing instruction page is a page prepared for the user to instruct the relay server 300 to execute printing. At this time, the web browser 561 transmits, to the relay server 300, the device identification information included in the code image C read by the reading unit 550 together with the request to acquire the printing instruction page. That is, in the embodiment, the identification information transmission unit 562 implemented as the web browser 561 transmits the device identification information to the relay server 300. Accordingly, the device identification information acquisition unit 334 of the relay server 300 acquires the device identification information specifying the image forming device 600 used for printing.

In the embodiment, as described above, authentication printing is performed in the printing system 10. Therefore, in step S402 to step S411, user authentication using the authentication function of the first printing service system 100 is performed. When the authentication in the first printing service system 100 is already normally completed for the user who performs the operation in step S400, processes in step S402 to step S411 may be omitted.

In step S402, the authentication control unit 331 of the relay server 300 instructs the web browser 561 to access a predetermined redirect page. In the present step, the predetermined redirect page is an authentication page. Therefore, the authentication control unit 331 of the relay server 300 transmits a URL of the authentication page to the web browser 561 of the second terminal device 500. As can be seen from step S401 and step S402, the authentication control unit 331 notifies the second terminal device 500 of an access destination for transmitting authentication information to the first printing service system 100 in response to the access from the second terminal device 500 that is based on the code image C read by the second terminal device 500. Accordingly, the second terminal device 500 can automatically obtain the access destination for authentication.

In step S403, the web browser 561 of the second terminal device 500 transmits a request to the first printing service system 100 to acquire the authentication page according to the received URL. On the other hand, in step S404, the authentication control unit 131 of the first printing service system 100 transmits the authentication page to the web browser 561. Accordingly, in step S405, the web browser 561 displays the authentication page on the display unit 520 of the second terminal device 500.

In step S406, the user who performs the operation in step S400 inputs the authentication information to the authentication page via the input unit 530. Specifically, the user inputs his or her user ID, a password, and the like. Here, the required authentication information is authentication information used in the first printing service system 100. Specifically, the required authentication information is a user ID and a password that are registered in advance. In step S407, the web browser 561 transmits the input authentication information to the first printing service system 100. The authentication control unit 131 of the first printing service system 100 performs an authentication process based on the authentication information received from the web browser 561 of the second terminal device 500. That is, the authentication control unit 131 determines whether the received authentication information matches the authentication information on the administrator that is registered in advance.

When the authentication is successful in the authentication process, that is, when the received authentication information matches the authentication information on the user that is registered in advance, in step S408, the authentication control unit 131 of the first printing service system 100 issues an authentication code and instructs the web browser 561 to access a predetermined redirect destination. The predetermined redirect destination is the relay server 300. By this redirect, the authentication code is passed to the relay server 300. Therefore, the authentication control unit 131 of the first printing service system 100 transmits a URL indicating the predetermined redirect destination to the web browser 561 of the second terminal device 500 together with the authentication code.

In step S409, the web browser 561 of the second terminal device 500 accesses the predetermined redirect destination with the authentication code. Accordingly, the relay server 300 acquires the authentication code. In step S410, the authentication control unit 331 of the relay server 300 transmits a request to the first printing service system 100 to generate an access token, together with the received authentication code. The access token is information certifying that the access is a legitimate access by the user of the first printing service system 100, that is, an access with legitimate authority of the user, and corresponds to the authentication completion information. That is, the access token indicates that the authentication by the first printing service system 100 for the authentication information on the user is completed. In step S411, after confirming that the authentication code received in step S410 matches the authentication code transmitted in step S408, the authentication control unit 131 of the first printing service system 100 issues an access token and transmits the access token to the relay server 300. Accordingly, the authentication control unit 331 of the relay server 300 acquires the access token, that is, the authentication completion information. When the authentication completion information is not obtained, the relay server 300 ends the process without executing subsequent processes.

Next, in step S412, the printing control unit 335 of the relay server 300 transmits a request to the first printing service system 100 to acquire the user ID of the user who performs the operation in step S400, together with the access token acquired in step S411. On the other hand, in step S413, when the authentication control unit 131 confirms that the access token received in step S412 is legitimate, the information management unit 133 of the first printing service system 100 transmits the user ID to the relay server 300. Specifically, the information management unit 133 transmits the user ID managed by the first printing service system 100 to the relay server 300. Accordingly, the printing control unit 335 of the relay server 300 acquires the user ID of the user who performs the operation in step S400.

Next, in step S414, the printing control unit 335 of the relay server 300 transmits a request to the first printing service system 100 to acquire an organization ID of the user who performs the operation in step S400, together with the access token acquired in step S411. The organization ID of the user is identification information on a user organization to which the user belongs. As described above, in the embodiment, the rule is set for each user organization. Therefore, it is necessary to acquire the organization ID of the user in order to specify the rule to be applied to the user. On the other hand, in step S415, when the authentication control unit 131 confirms that the access token received in step S414 is legitimate, the information management unit 133 of the first printing service system 100 transmits the organization ID of the user to the relay server 300. Specifically, the information management unit 133 transmits the organization ID to the relay server 300. Accordingly, the printing control unit 335 of the relay server 300 acquires the organization ID of the user. As described above, the printing control unit 335 acquires the organization information on the user organization to which the user belongs (the organization ID) from the first printing service system 100, and determines the rule to be applied to the user based on the acquired organization information. Therefore, even when various organizations use the printing system 10, the rule can be applied as appropriate. The printing control unit 335 uses the access token corresponding to the authentication completion information in order to acquire the organization information on the user organization (the organization ID) from the first printing service system 100. Therefore, when the authentication of the user is not completed normally, the printing control unit 335 interrupts the process. Therefore, unauthorized use of the system can be prevented.

Next, in step S416, the printing control unit 335 reads out the rule stored in advance. Specifically, the printing control unit 335 reads out a rule associated with the organization ID acquired in step S415 among the rules stored in the storage unit 310. In step S417, when an instruction related to application of the rule is stored, the printing control unit 335 reads out the instruction. Specifically, the printing control unit 335 reads out an instruction associated with the user ID acquired in step S413 among instructions stored in the storage unit 310. When the instruction associated with the user ID acquired in step S413 is not yet stored, the instruction in the present step is not read.

In step S418, the printing control unit 335 refers to the read rule and instruction and performs, based on the read rule and instruction, determination related to the use of the image forming device 600 identified by the device identification information acquired in step S401. When the image forming device 600 identified by the device identification information acquired in step S401 is a printer permitted to be used without a warning, the printing control unit 335 associates the image forming device 600 identified by the device identification information acquired in step S401 with a code virtual printer, and immediately executes processes in step S426 and subsequent steps. On the other hand, when the image forming device 600 identified by the device identification information acquired in step S401 is a printer required for a warning notification, processes in step S419 to step S423 are executed. When the image forming device 600 identified by the device identification information acquired in step S401 is a printer prohibited from being used, processes in step S424 and step S425 are executed.

First, a flow of a process when the image forming device 600 identified by the device identification information acquired in step S401 is a printer required for a warning notification will be described. In step S419, the printing control unit 335 of the relay server 300 transmits a warning page to the web browser 561. Accordingly, in step S420, the web browser 561 displays an warning page on the display unit 520 of the second terminal device 500. The warning page is a page for warning of the use of the image forming device 600 identified by the device identification information acquired in step S401. Accordingly, in the sequence chart shown here, in step S419, a warning based on the rule is given a notification. The warning page may also be a page for providing a user interface for inputting a user instruction for a warning. For example, a button for instructing whether to use or reject the image forming device 600 may be disposed on the warning page. For example, a button for selecting whether to refuse the use only this time or to refuse the use the next and subsequent times may be disposed on the warning page. For example, a button for instructing to omit a warning for the use of the image forming device 600 in the future may be disposed on the warning page. A button for selecting all the image forming devices 600 managed by a specific organization as a use rejection target or a warning omission target may be disposed. Since the warning can be omitted only when a rule that enables the warning omission is set in the image forming device 600, the printing control unit 335 creates a warning page according to the rule referred to in step S416 and transmits the warning page to the second terminal device 500.

In step S421, after confirming the warning page, the user inputs an instruction related to the use of the image forming device 600. The user at least inputs an instruction to use or reject the image forming device 600 as the warning target. The user inputs an instruction related to application of the rule, which is an instruction to omit a warning, as necessary. For example, the user inputs the instruction by operating a button disposed on the warning page, but the input may also be performed by other methods.

Next, in step S422, the web browser 561 transmits the user instruction input in step S421 to the relay server 300. That is, in the embodiment, the instruction transmission unit 563 implemented as the web browser 561 transmits the user instruction to the relay server 300. Accordingly, the relay server 300 receives the instruction.

When the instruction received in step S422 includes an instruction related to application of the rule, in step S423, the setting management unit 333 stores the instruction in the storage unit 310. Specifically, for example, in step S422, when an instruction to omit a warning and an instruction to reject continuous use are received, the setting management unit 333 stores the instruction in the storage unit 310 in association with the user ID acquired in step S413. When the instruction target is only one image forming device 600, the printing control unit 335 stores the device identification information on the image forming device 600 (the printer ID) and the instruction in the storage unit 310 in association with each other. When the instruction target is all image forming devices 600 of the specific organization, the printing control unit 335 stores the organization ID of the organization and the instruction in the storage unit 310 in association with each other.

When the instruction received by the relay server 300 in step S422 is an instruction to use the image forming device 600 as the warning target, the printing control unit 335 associates the image forming device 600 with the code virtual printer, and the process proceeds to step S426. On the other hand, when the instruction received by the relay server 300 in step S422 is an instruction not to use the image forming device 600 as the warning target, the process ends. In this case, the user moves to another image forming device 600 and performs the process in step S400 again.

Next, a flow of a process when the image forming device 600 identified by the device identification information acquired in step S401 is a printer prohibited from being used will be described. In this case, in step S424, the printing control unit 335 of the relay server 300 transmits a printer unavailable page to the web browser 561. Accordingly, in step S425, the web browser 561 displays the printer unavailable page on the display unit 520 of the second terminal device 500. The printer unavailable page is a page for notifying that the use of the image forming device 600 identified by the device identification information acquired in step S401 is prohibited. When the use of the image forming device 600 is prohibited according to the rule corresponding to the image forming device 600 identified by the device identification information acquired in step S401 or the user instruction, the processes in step S424 and step S425 are performed. In this case, the user moves to another image forming device 600 and performs the process in step S400 again.

In step S426, the printing control unit 335 of the relay server 300 transmits a printing instruction page to the web browser 561. Accordingly, in step S427, the web browser 561 displays the printing instruction page on the display unit 520 of the second terminal device 500. The printing instruction page is a page for receiving a printing instruction from the user. For example, a printing button, which is a button for the user to instruct the printing system 10 to execute printing, is disposed on the printing instruction page. In step S428, the user presses the printing button displayed on the printing instruction page. In step S429, the web browser 561 transmits an instruction to the relay server 300 to execute printing. That is, in the embodiment, the instruction transmission unit 563 implemented as the web browser 561 transmits the instruction to execute printing. Accordingly, the printing control unit 335 of the relay server 300 receives the instruction to execute printing.

When the relay server 300 receives the instruction to execute printing, in step S430, the printing control unit 335 of the relay server 300 performs a reading process of the database of the storage unit 310 or the like in order to acquire the virtual printer ID of the code virtual printer. Accordingly, in step S431, the printing control unit 335 reads out the virtual printer ID of the code virtual printer.

Next, in step S432, the printing control unit 335 of the relay server 300 acquires a list of printing jobs for printing data to be printed by the image forming device 600 identified by the device identification information included in the code image C. Specifically, the printing control unit 335 transmits a request to the first printing service system 100 to acquire the job list. More specifically, the printing control unit 335 transmits the request together with the virtual printer ID acquired in step S431 and the user ID acquired in step S413. On the other hand, in step S433, the printing control unit 132 of the first printing service system 100 transmits, to the relay server 300, the list of printing jobs stored in the first printing service system 100. That is, the printing control unit 132 of the first printing service system 100 transmits the job list of the printing jobs that are associated with the code virtual printer and also associated with the received user ID. When the job list is transmitted from the first printing service system 100, processes in step S434 to step S444 are performed for each printing job listed in the job list.

In step S434, the printing control unit 335 of the relay server 300 transmits a request to the first printing service system 100 to acquire job information. Specifically, the printing control unit 335 transmits the request together with the virtual printer ID notified in step S431 and the job ID listed in the job list acquired in step S433. On the other hand, in step S435, the printing control unit 132 of the first printing service system 100 transmits, to the relay server 300, printing setting corresponding to the job ID and a URL indicating a storage location of the printing data corresponding to the job ID as the job information. In the following description, the URL indicating a storage location of the printing data is referred to as a printing data URL.

When the relay server 300 receives the job information, in step S436, the printing control unit 335 of the relay server 300 performs a reading process of the database of the storage unit 310 or the like in order to acquire information necessary for access to the image forming device 600 identified by the device identification information included in the code image C. Accordingly, in step S437, the printing control unit 335 reads out the information required to access. In the embodiment, specifically, the information required to access the image forming device 600 is an e-mail address assigned in advance to the image forming device 600 identified by the device identification information included in the code image C, and an access key such as a password. This information is stored in advance in the database of the storage unit 310 of the relay server 300 or the like. When such information is unnecessary for accessing the image forming device 600, step S436 and step S437 may be omitted.

Next, in step S438, the printing control unit 335 of the relay server 300 requests the second printing service system 200 to execute printing. At this time, the printing control unit 335 transmits, to the second printing service system 200, the printer e-mail address and the access key that are read out in step S437 and the printing setting and the printing data URL that are acquired in step S435. As described above, the printing control unit 335 requests the second printing service system 200 to execute printing by the image forming device 600 identified by the device identification information included in the code image C.

As described above, when acquiring a printing instruction from the second terminal device 500, the printing control unit 335 acquires the printing job from the first printing service system 100 and transmits a request to the second printing service system 200 to cause the image forming device 600 to execute printing for the printing job. Accordingly, in the system in which the first printing service system 100 and the second printing service system 200 cooperate with each other, the image forming device 600 can execute printing. In the flow of the process described above, the user gives a printing instruction for one or more printing jobs at once, but the user may give an individual printing instruction. In this case, the printing control unit 335 acquires the list of printing jobs from the first printing service system 100, transmits the list to the second terminal device 500, acquires, from the second terminal device 500, the printing instruction for the printing job selected from the list, and acquires the selected printing job from the first printing service system 100. According to such a configuration, the user can select whether to perform printing for each printing job, and thus the user convenience is improved.

Here, a process for the relay server 300 to acquire the printing job from the first printing service system 100 will be further described. In the above description, from step S432 to step S435, the process for the relay server 300 to acquire the printing job from the first printing service system 100 is performed. An access token may be required during the process. That is, in step S432, the printing control unit 335 of the relay server 300 may transmit a request to the first printing service system 100 to acquire a job list, together with the access token acquired in step S411. In step S433, when the authentication control unit 131 confirms that the received access token is legitimate, the printing control unit 132 of the first printing service system 100 may transmit the job list to the relay server 300. Similarly, in step S434, the printing control unit 335 of the relay server 300 may transmit a request to the first printing service system 100 to acquire job information, together with the access token acquired in step S411. In step S435, when the authentication control unit 131 confirms that the received access token is legitimate, the printing control unit 132 of the first printing service system 100 may transmit the job information to the relay server 300. As described above, the printing control unit 335 may acquire the printing job for the user from the first printing service system 100 using the access token corresponding to the authentication completion information, and transmit a request to the second printing service system 200 to cause the image forming device 600 to execute printing for the printing job. As described above, when the authentication completion information is required to acquire the printing job, the printing control unit 335 interrupts the process in a case where the authentication of the user is not normally completed. Therefore, unauthorized use of the system can be prevented. It can be interpreted that even when the access token is not required during the processes in step S432 to step S435, in the embodiment, the printing control unit 335 uses the authentication completion information to acquire the printing job for the user from the first printing service system 100. This is because the user ID (see step S412 and step S413) is required, which is information acquired only when it is confirmed that the access token is legitimate in step S432 and step S433.

When the second printing service system 200 receives a printing request from the relay server 300, in step S439, the printing control unit 231 of the second printing service system 200 accesses the printing data URL notified in step S438 in order to acquire the printing data. Accordingly, in step S440, the printing control unit 231 of the second printing service system 200 acquires the printing data from the first printing service system 100.

After step S440, in step S441, the printing control unit 231 converts the printing data acquired in step S440 into printing data conforming to a predetermined printer language. Thereafter, in step S442, the printing control unit 231 notifies the image forming device 600, which is a printer used for printing, of the presence of a printing job for printing the converted printing data. The printing job is a printing job corresponding to the printing job managed by the first printing service system 100, and is a printing job managed by the printing control unit 231 of the second printing service system 200. Therefore, a new ID is assigned in addition to the job ID value described above. Hereinafter, the ID of the printing job managed by the printing control unit 231 of the second printing service system 200 is referred to as a job ID2. In step S443, the printing control unit 231 of the second printing service system 200 notifies the relay server 300 of the job ID2. On the other hand, in step S444, the printing control unit 335 of the relay server 300 performs a process of storing a correspondence relationship between the printing job of the first printing service system 100 and the printing job of the second printing service system 200. Specifically, the printing control unit 335 stores the virtual printer ID, the job ID of the first printing service system 100, the device identification information on the image forming device 600 used for printing (the printer ID), and the job ID of the second printing service system 200, that is, the job ID2, in association with one another in the database of the storage unit 310 or the like.

When the processes in step S434 to step S444 are performed for all the printing jobs listed in the job list acquired in step S433, the process proceeds to step S445. In step S445, the printing control unit 335 of the relay server 300 transmits a printing reception page to the web browser 561. Accordingly, in step S446, the web browser 561 displays the printing reception page on the display unit 520 of the second terminal device 500. The printing reception page is a page for notifying that the printing instruction from the user is normally received. The printing reception page is also a page for receiving a printing stop instruction from the user. Therefore, a cancel button, which is a button for the user to instruct the printing system 10 to stop printing, is disposed on the printing reception page. The user can press the cancel button displayed on the printing reception page as necessary. Hereinafter, processes (step S447 to step S453) executed in the printing system 10 when the cancel button is pressed by the user before processes in step S454 and subsequent steps to be described later are started will be described.

The user who desires to stop printing presses the cancel button displayed on the printing reception page in step S447. In step S448, the web browser 561 transmits a printing stop instruction to the relay server 300. That is, in the embodiment, the instruction transmission unit 563 implemented as the web browser 561 transmits the printing stop instruction. Accordingly, the relay server 300 receives the printing stop instruction.

When the relay server 300 receives the printing stop instruction, the processes in step S449 to step S451 are performed for each printing job. In step S449, the printing control unit 335 of the relay server 300 designates a printing job by the job ID2 and requests the second printing service system 200 to cancel the process of the printing job. At this time point, since the printing process executed by the image forming device 600 is not started yet, the printing control unit 231 of the second printing service system 200 cancels the printing job in step S450. Then, the printing control unit 231 transmits, to the relay server 300, a cancel result indicating that the cancel is successful. When the relay server 300 receives the cancel result from the second printing service system 200, in step S451, the printing control unit 335 of the relay server 300 notifies the first printing service system 100 of the job state together with the virtual printer ID of the code virtual printer and the job ID as a cancel target. Specifically, the printing control unit 335 notifies the first printing service system 100 of a job state indicating that the cancel is performed. As described above, when the printing control unit 335 acquires the cancel result (that is, the job state) from the second printing service system 200, the printing control unit 335 transmits the job state to the first printing service system 100.

When the processes in step S449 to step S451 are performed for all the printing jobs as cancel targets, the process proceeds to step S452. In step S452, the printing control unit 335 of the relay server 300 transmits a cancel result page to the web browser 561. Accordingly, in step S453, the web browser 561 displays the cancel result page on the display unit 520 of the second terminal device 500. The cancel result page is a page for notifying whether the process for each printing job is cancelled in response to the printing stop instruction from the user. That is, the cancel result page is a page for notifying whether the printing is normally stopped. At a time point when the printing process executed by the image forming device 600 is not started, the printing is successfully stopped, and thus the cancel result page indicating that the printing is successfully stopped is displayed in step S453. The cancel result page transmitted in step S452 may include the number of printing jobs for which the printing is successfully stopped and the number of printing jobs for which the printing failed to be stopped.

When the cancel button is not pressed before the processes in step S454 and the subsequent steps are started, processed in step S454 to step S485 are performed for each printing job.

In step S454, the printing processing unit 641 of the image forming device 600 corresponding to the device identification information included in the code image C transmits a request to the second printing service system 200 to acquire printing data. On the other hand, in step S455, the printing control unit 231 of the second printing service system 200 transmits the converted printing data to the image forming device 600.

After step S455, the processes in step S456 to step S466 are executed every time the job state changes. The processes are executed when the printing process is started in the image forming device 600 or when an error occurs after the printing process is started.

In step S456, the printing processing unit 641 of the image forming device 600 notifies the second printing service system 200 of the job state. When the second printing service system 200 receives this notification, in step S457, the printing control unit 231 of the second printing service system 200 notifies the relay server 300 of the job state notified in step S456 together with the printer ID and the job ID2. Accordingly, the printing control unit 335 of the relay server 300 acquires the job state of the printing process executed by the image forming device 600.

When the relay server 300 receives the notification of the job state, in step S458, the printing control unit 335 of the relay server 300 performs a reading process of the database of the storage unit 310 or the like to acquire information stored in association with the received printer ID and job ID2. Accordingly, in step S459, the printing control unit 335 reads out the virtual printer ID and the job ID that are stored in association with the printer ID and the job ID2. In step S460, the printing control unit 335 of the relay server 300 notifies the first printing service system 100 of the job state notified in step S457 together with the virtual printer ID and the job ID. That is, when the printing control unit 335 acquires the job state from the second printing service system 200, the printing control unit 335 transmits the job state to the first printing service system 100.

In step S461, the state output unit 564 of the second terminal device 500 transmits a request to the first printing service system 100 to acquire the job information by designating the virtual printer ID and the job ID. On the other hand, in step S462, the printing control unit 132 of the first printing service system 100 transmits the job state received in step S460 to the second terminal device 500. Accordingly, in step S463, the state output unit 564 of the second terminal device 500 displays the job state on the display unit 520 of the second terminal device 500.

The job states may be displayed on the first terminal device 400. In this case, in step S464, the state output unit 453 of the first terminal device 400 transmits a request to the first printing service system 100 to acquire the job information by designating the virtual printer ID and the job ID. On the other hand, in step S465, the printing control unit 132 of the first printing service system 100 transmits the job state received in step S460 to the first terminal device 400. Accordingly, in step S466, the state output unit 453 of the first terminal device 400 displays the job state on the display unit 420 of the first terminal device 400.

As can be seen from this sequence chart, each time the job state is updated, the printing control unit 335 of the relay server 300 transmits the updated job state to the first printing service system 100. Therefore, the user can appropriately grasp the current job state via the first printing service system 100.

Next, processes (step S467 to step S474) executed in the printing system 10 when the cancel button is pressed after the process in step S454 is started will be described.

The user who desires to stop printing presses the cancel button displayed on the printing reception page in step S467. In step S468, the web browser 561 transmits a printing stop instruction to the relay server 300. That is, in the embodiment, the instruction transmission unit 563 implemented as the web browser 561 transmits the printing stop instruction. Accordingly, the relay server 300 receives the printing stop instruction.

When the relay server 300 receives the printing stop instruction, the processes in step S469 to step S472 are performed for each printing job. Here, when the job state notified by the relay server 300 from the second printing service system 200 for the printing job as a stop target is a printing-in-progress state or a printing end state, the process in step S469 is performed. In step S469, the printing control unit 335 of the relay server 300 determines that the cancel of the printing process is failed for the printing job. On the other hand, for the printing job as the stop target, when the job state notified by the relay server 300 from the second printing service system 200 is a state before a start of the printing, the processes in step S470 and step S471 are performed. In step S470, the printing control unit 335 of the relay server 300 designates the printing job by the job ID2 and requests the second printing service system 200 to cancel the process for the printing job. On the other hand, when the image forming device 600 does not start the printing for the printing job, the printing control unit 231 of the second printing service system 200 cancels the printing job in step S471. Then, the printing control unit 231 transmits a cancel result indicating that the cancel is successful to the relay server 300. However, there may be a case where printing for the printing job is already started by the image forming device 600. For example, such a case may occur due to a time lag in notifying the relay server 300 of the latest job state. In this case, in step S471, the printing control unit 231 of the second printing service system 200 fails to cancel the printing job and transmits a cancel result indicating that the cancel is failed to the relay server 300. When receiving the cancel result indicating that the cancel is successful from the second printing service system 200, in step S472, the printing control unit 335 of the relay server 300 notifies the first printing service system 100 of the job state together with the virtual printer ID of the code virtual printer and the job ID to be cancelled. Specifically, the printing control unit 335 notifies the first printing service system 100 of a job state indicating that the cancel is performed.

When the processes in step S469 and subsequent steps are performed for all the printing jobs as cancel targets, the process proceeds to step S473. In step S473, the printing control unit 335 of the relay server 300 transmits the cancel result page to the web browser 561. The cancel result page includes the number of printing jobs for which the printing is successfully stopped and the number of printing jobs for which the printing failed to be stopped. In step S474, the web browser 561 displays the cancel result page on the display unit 520 of the second terminal device 500.

When the cancel button is not pressed after the process in step S454 is started, the processes in step S475 and subsequent steps are performed after the processes in step S456 to step S466 described above.

In step S475, when the printing process for the printing job ends, the printing processing unit 641 of the image forming device 600 notifies the second printing service system 200 of end of the printing by giving a notification of a processing result of the printing job. Specifically, the printing processing unit 641 notifies whether the printing process is normally completed. That is, the printing processing unit 641 notifies whether the printing is successful or failed. When the second printing service system 200 receives this notification, in step S476, the printing control unit 231 of the second printing service system 200 notifies the relay server 300 of the processing result notified in step S475 as the job state together with the printer ID and the job ID2. Accordingly, the printing control unit 335 of the relay server 300 acquires the job state of the printing process executed by the image forming device 600.

When the relay server 300 receives the notification of the job state, in step S477, the printing control unit 335 of the relay server 300 performs a reading process of the database of the storage unit 310 or the like to acquire information stored in association with the received printer ID and job ID2. Accordingly, in step S478, the printing control unit 335 reads out the virtual printer ID and the job ID stored in association with the printer ID and the job ID2.

Next, in step S479, the printing control unit 335 of the relay server 300 notifies the first printing service system 100 of the job state together with the virtual printer ID and the job ID. That is, when the printing control unit 335 acquires the job state from the second printing service system 200, the printing control unit 335 transmits the job state to the first printing service system 100.

In step S480, the state output unit 564 of the second terminal device 500 transmits a request to the first printing service system 100 to acquire the job information by designating the virtual printer ID and the job ID. On the other hand, in step S481, the printing control unit 132 of the first printing service system 100 transmits the job state received in step S479 to the second terminal device 500. Accordingly, in step S482, the state output unit 564 of the second terminal device 500 displays the job state on the display unit 520 of the second terminal device 500.

The job state may be displayed on the first terminal device 400. In this case, in step S483, the state output unit 453 of the first terminal device 400 transmits a request to the first printing service system 100 to acquire the job information by designating the virtual printer ID and the job ID. On the other hand, in step S484, the printing control unit 132 of the first printing service system 100 transmits the job state received in step S479 to the first terminal device 400. Accordingly, in step S485, the state output unit 453 of the first terminal device 400 displays the job state on the display unit 420 of the first terminal device 400.

The printing system 10 according to the embodiment has been described above. According to the printing system 10, authentication printing using authentication by the first printing service system 100 can be implemented in the printing system in which different systems that provide printing service cooperate with each other. Therefore, unauthorized use of the system can be prevented. Even when the second printing service system 200 does not have an authentication function, authentication printing can be implemented in printing by the image forming device 600 connected to the second printing service system 200. Further, according to the printing system 10, even in the printing system in which different systems that provide printing service cooperate with each other, the user can designate the image forming device 600 to be used for printing by using the code image C attached to the image forming device 600. Therefore, erroneous selection of the image forming device 600 to be used can be reduced, compared to a case where the user selects the image forming device 600 to be used on the screen. Therefore, the user convenience is improved.

The present disclosure is not limited to the embodiment described above, and can be appropriately modified without departing from the scope of the present disclosure. For example, the relay server 300 may be provided in the second printing service system 200. According to such a configuration, for example, the same vendor can easily manage the relay server 300 and the second printing service system 200. In the embodiment described above, the second printing service system 200 acquires the printing data from the first printing service system 100, but the relay server 300 may acquire the printing data from the first printing service system 100, and the relay server 300 may transmit the printing data to the second printing service system 200. In the embodiment described above, the relay server 300 performs the process for enabling designation of the image forming device 600 using the code image C in order to execute printing by the image forming device 600 connected to the second printing service system 200. However, the relay server 300 may perform a process of enabling designation of the image forming device using the code image C in order to execute printing by the image forming device connected to the first printing service system 100. In this case, the relay server 300 may perform, with the first printing service system 100, the process described in the embodiment as the process performed with the second printing service system 200. In the embodiment described above, the printing system 10 includes a technique for implementing authentication printing and a technique for designating an image forming device using a code image, but a printing system including only one of the techniques may be provided.

In the example described above, a program includes an instruction group (or a software code) for causing the computer to perform one or more functions described in the embodiment when the program is read by the computer. The program may be stored in a non-transitory computer-readable medium or a tangible storage medium. Examples of the computer-readable medium or tangible storage medium include, but not limited to, a random-access memory (RAM), a read-only memory (ROM), a flash memory, a solid-state drive (SSD), other memory technologies, a CD-ROM, a digital versatile disk (DVD), a Blu-ray (registered trademark) disk, other optical disk storage, a magnetic cassette, a magnetic tape, and a magnetic disk storage or other magnetic storage device. The program may be transmitted on a transitory computer-readable medium or a communication medium. Examples of the transitory computer-readable medium or communication medium include, but not limited to, electrical, optical, acoustic, or other forms of propagating signals.

A part or all of the embodiment described above may be described as in the following appendixes, but are not limited thereto.

### Appendix 1

A server connected to a first printing service system and a second printing service system, the second printing service system being connected to an image forming device, the server including:
an authentication control unit configured to acquire authentication completion information indicating that authentication by the first printing service system for authentication information on a user which is input to a terminal device is completed; and
a printing control unit configured to acquire a printing job for the user from the first printing service system using the authentication completion information and transmit a request to the second printing service system to cause the image forming device to execute printing for the printing job.

### Appendix 2

The server according to appendix 1, in which
the authentication control unit notifies the terminal device of an access destination for transmitting the authentication information to the first printing service system in response to an access from the terminal device based on a code image read by the terminal device.

### Appendix 3

The server according to appendix 1 or 2, in which
a code image including identification information on the image forming device is attached to the image forming device,
the server further includes a storage unit configured to store a predetermined rule related to use of the image forming device, and
the printing control unit refers to the rule applied to the user, the rule being related to the use of the image forming device identified by the identification information transmitted from the terminal device by which the code image is read, and executes a process of controlling the use of the image forming device identified by the identification information by the user according to the referred rule.

### Appendix 4

The server according to appendix 3, in which
the process includes prohibiting the use of the image forming device identified by the identification information.

### Appendix 5

The server according to appendix 3 or 4, in which
the process includes transmitting a notification to the terminal device warning of the use of the image forming device identified by the identification information.

### Appendix 6

The server according to any one of appendixes 3 to 5, in which
the storage unit stores a different one of the rule on a user organization basis, and
the printing control unit acquires organization information on a user organization to which the user belongs from the first printing service system using the authentication completion information, and determines the rule to be applied to the user based on the acquired organization information.

### Appendix 7

The server according to any one of appendixes 1 to 6, in which
when acquiring a printing instruction from the terminal device, the printing control unit acquires the printing job from the first printing service system, and transmits the request to the second printing service system to cause the image forming device to execute printing for the printing job.

### Appendix 8

The server according to appendix 7, in which
the printing control unit acquires a list of the printing jobs from the first printing service system, transmits the list to the terminal device, acquires, from the terminal device, the printing instruction for the printing job selected from the list, and acquires the selected printing job from the first printing service system.

### Appendix 9

The server according to any one of appendixes 1 to 8, in which
a code image including identification information on the image forming device is attached to the image forming device,
the printing control unit transmits the request to the second printing service system to cause the image forming device identified by the identification information transmitted from the terminal device by which the code image is read to execute printing for the printing job, and
when acquiring a printing stop instruction from the terminal device, the printing control unit transmits a printing stop request to the second printing service system, acquires information on whether printing is successfully stopped from the second printing service system, and notifies the terminal device of the information.

### Appendix 10

The server according to any one of appendixes 1 to 9, in which
the printing control unit acquires a job state of the printing job from the second printing service system and notifies the first printing service system of the job state.

### Appendix 11

The server according to any one of appendixes 1 to 10, in which
the server is included in the second printing service system.

### Appendix 12

A printing system including:
a first printing service system;
an image forming device;
a second printing service system connected to the image forming device; and
a server connected to the first printing service system and the second printing service system, in which
the server includes
   an authentication control unit configured to acquire authentication completion information indicating that authentication by the first printing service system for authentication information on a user which is input to a terminal device is completed, and
   a printing control unit configured to acquire a printing job for the user from the first printing service system using the authentication completion information and transmit a request to the second printing service system to cause the image forming device to execute printing for the printing job.

### Appendix 13

An information processing method causing a server connected to a first printing service system and a second printing service system, the second printing service system being connected to an image forming device, to
acquire authentication completion information indicating that authentication by the first printing service system for authentication information on a user which is input to a terminal device is completed, and
acquire a printing job for the user from the first printing service system using the authentication completion information and transmit a request to the second printing service system to cause the image forming device to execute printing for the printing job.

### Appendix 14

A non-transitory computer-readable storage medium storing a program, the program causing a computer of a server connected to a first printing service system and a second printing service system, the second printing service system being connected to an image forming device, to execute:
an authentication control step of acquiring authentication completion information indicating that authentication by the first printing service system for authentication information on a user which is input to a terminal device is completed; and
a printing control step of acquiring a printing job for the user from the first printing service system using the authentication completion information and transmitting a request to the second printing service system to cause the image forming device to execute printing for the printing job.

What is claimed is:

1. A server connected to a first printing service system and a second printing service system, the second printing service system being connected to an image forming device, the server comprising:
an authentication controller configured to acquire authentication completion information indicating that authentication by the first printing service system for authentication information on a user which is input to a terminal device is completed; and
a printing controller configured to acquire a printing job for the user from the first printing service system using the authentication completion information and transmit a request to the second printing service system to cause the image forming device to execute printing for the printing job.

2. The server according to claim 1, wherein
the authentication controller notifies the terminal device of an access destination for transmitting the authentication information to the first printing service system in response to an access from the terminal device based on a code image read by the terminal device.

3. The server according to claim 1, wherein
a code image including identification information on the image forming device is attached to the image forming device,
the server further includes a storage configured to store a predetermined rule related to use of the image forming device, and
the printing controller refers to the rule applied to the user and related to the use of the image forming device identified by the identification information transmitted from the terminal device by which the code image is read, and executes a process of controlling the use of the image forming device identified by the identification information by the user according to the referred rule.

4. The server according to claim 3, wherein
the process includes prohibiting the use of the image forming device identified by the identification information.

5. The server according to claim 3, wherein
the process includes transmitting to the terminal device a notification warning of the use of the image forming device identified by the identification information.

6. The server according to claim 3, wherein
the storage stores a different one of the rule on a user organization basis, and
the printing controller acquires organization information on a user organization to which the user belongs from the first printing service system using the authentication completion information, and determines the rule to be applied to the user based on the acquired organization information.

7. The server according to claim 1, wherein
when acquiring a printing instruction from the terminal device, the printing controller acquires the printing job from the first printing service system, and transmits the request to the second printing service system to cause the image forming device to execute printing for the printing job.

8. The server according to claim 7, wherein
the printing controller acquires a list of the printing jobs from the first printing service system, transmits the list to the terminal device, acquires, from the terminal device, the printing instruction for the printing job selected from the list, and acquires the selected printing job from the first printing service system.

9. The server according to claim 1, wherein
a code image including identification information on the image forming device is attached to the image forming device,
the printing controller transmits the request to the second printing service system to cause the image forming device identified by the identification information transmitted from the terminal device by which the code image is read to execute printing for the printing job, and
when acquiring a printing stop instruction from the terminal device, the printing controller transmits a printing stop request to the second printing service system, acquires information on whether printing is successfully stopped from the second printing service system, and notifies the terminal device of the information.

10. The server according to claim 1, wherein
the printing controller acquires a job state of the printing job from the second printing service system and notifies the first printing service system of the job state.

11. The server according to claim 1, wherein
the server is included in the second printing service system.

12. A printing system comprising:
a first printing service system;
an image forming device;
a second printing service system connected to the image forming device; and
a server connected to the first printing service system and the second printing service system, wherein
the server includes
an authentication controller configured to acquire authentication completion information indicating that authentication by the first printing service system for authentication information on a user which is input to a terminal device is completed, and
a printing controller configured to acquire a printing job for the user from the first printing service system using the authentication completion information and transmit a request to the second printing service system to cause the image forming device to execute printing for the printing job.

13. An information processing method causing a server connected to a first printing service system and a second printing service system, the second printing service system being connected to an image forming device, to
acquire authentication completion information indicating that authentication by the first printing service system for authentication information on a user which is input to a terminal device is completed, and
acquire a printing job for the user from the first printing service system using the authentication completion information and transmit a request to the second printing service system to cause the image forming device to execute printing for the printing job.

14. A non-transitory computer-readable storage medium storing a program, the program causing a computer of a server connected to a first printing service system and a second printing service system, the second printing service system being connected to an image forming device, to execute:
an authentication control step of acquiring authentication completion information indicating that authentication by the first printing service system for authentication information on a user which is input to a terminal device is completed; and
a printing control step of acquiring a printing job for the user from the first printing service system using the authentication completion information and transmitting a request to the second printing service system to cause the image forming device to execute printing for the printing job.
